(19) United States
(12) Patent Application Publication
(10) Pub. No.: US 2024/0278208 A1
(43) Pub. Date: Aug. 22, 2024

(54) Metal Organic Frameworks Having Node Defects And Methods Of Making The Same

(71) Applicant: ExxonMobil Technology and Engineering Company, Annandale, NJ (US)

(72) Inventors: Joseph M. Falkowski, Hampton, NJ (US); Mary S. Abdulkarim, Palisades Park, NJ (US); Sophie Liu, Hampton, NJ (US); Scott J. Weigel, Allentown, PA (US); Trong D. Pham, Flemington, NJ (US)

(21) Appl. No.: 18/572,034

(22) PCT Filed: Jun. 23, 2022
(86) PCT No.: PCT/US2022/034730

§ 371 Date: Dec. 19, 2023

Related U.S. Application Data
(60) Provisional application No. 63/202,856, filed on Jun. 28, 2021.

(51) Int. Cl. B01J 20/22; B01J 20/02; B01J 20/28; B01J 20/30

(52) U.S. Cl. CPC B01J 20/226; B01J 20/0225; B01J 20/0237; B01J 20/0244; B01J 20/0251; B01J 20/0288; B01J 20/0296; B01J 20/28066; B01J 20/28071; B01J 20/28073; B01J 20/28076; B01J 20/3085

(57) ABSTRACT

Provided are metal-organic frameworks made by the process of comprising the steps of reacting a first metal source that can generate a tetravalent metal cation in solution, a linear dicarboxylic acid, a second metal source that can generate a divalent cation in solution, and one or more monocarboxylic acid modulators in a solvent to provide a reaction solution. The reaction solution is heated to provide a metal-organic framework having between about 0 wt. % to 10 wt. % of divalent cation, surface area between about 1100 m²/g and 2700 m²/g, a porosity of between about 0.45 cc/g and 1.1 cc/g, and a relative intensity equal to or greater than 0.35 and a peak width ratio of less than 3.0.

### CROSS REFERENCE TO RELATED APPLICATIONS

The present application claims priority to and the benefit of U.S. Provisional Application No. 63/202,856 filed on Jun. 28, 2021, which is hereby incorporated by reference in its entirety.

### FIELD

The present disclosure relates to incorporation of defects in metal-organic frameworks to increase surface area and micropore volume, and specifically relates to synthesis of novel metal-organic frameworks having tetravalent cations and terephthalate linkers, and methods of making the same.

### BACKGROUND

Metal-organic frameworks have organic linkers that bridge metal nodes through coordination bonds to form a coordination network. The topology of the metal-organic framework can be adjusted either through isoreticular expansion or functionalization of the organic linker and metal node. These tunable topologies make metal-organic frameworks customizable for a variety of applications ranging from catalytic transformations to adsorption and separations to biomedical applications. Metal-organic frameworks (“MOFs”) are relatively unstable when compared to traditional porous silica and alumina, however.

Instability of MOFs can be alleviated through the incorporation of trivalent metals such as aluminum, chromium and iron or tetravalent metals such as zirconium, hafnium and titanium. Furthermore, the resulting high degree of connectivity between metal clusters and linkers permits formation of defects at high concentrations without the collapse of the overall structure. The under-coordinated metal ions can serve as catalytically active sites or anchoring sites for other active elements.

Control of defect formation is essential to achieving desired properties while maintaining a well-defined and tunable metal-organic framework. To date, control mechanisms generating missing-cluster defects (node defects) are not at the level of sophistication of missing linker defects. While certain modulators have been shown effective in adjusting missing-linker defects, modulators which promote node defects are limited unless excessive concentrations are used. Further, certain effective modulators such as fluorinated carboxylic acids are environmentally undesirable.

### SUMMARY

Provided herein are metal-organic frameworks comprising a plurality of tetravalent cations and terephthalate linkers crystallized in a primitive cubic lattice and having a surface area between about 1100 m²/g and 2700 m²/g, a porosity of between about 0.45 cc/g and 1.1 cc/g, and a relative intensity equal to or greater than 0.35.

Provided herein are metal-organic frameworks made by the process of comprising the steps of reacting a first metal source that can generate a tetravalent metal cation in solution, a linear dicarboxylic acid, a second metal source that can generate a divalent cation in solution, and one or more monocarboxylic acid(s) modulator(s) in a solvent to provide a reaction solution, and heating the reaction solution to provide a reaction mixture, and the metal-organic framework comprises between about 0 wt. % to 10 wt. % of divalent cation, surface area between about 1100 m²/g and 2700 m²/g, a porosity of between about 0.45 cc/g and 1.1 cc/g, and a relative intensity equal to or greater than 0.35 and/or a peak width ratio of less than 3.0.

Also provided herein are metal-organic frameworks comprising a plurality of zirconium cations and a plurality of BDC (benzene dicarboxylate) linkers in a primitive cubic lattice, and between about 0.0 wt. % to 10.0 wt. % of divalent cation. The metal-organic framework has a surface area as measured by nitrogen BET of between about 1100 m²/g and 2700 m²/g, a porosity of between about 0.45 cc/g and 1.1 cc/g, and a relative intensity equal to or greater than 0.35.

Further provided herein are metal organic frameworks comprising a plurality of zirconium cations and BDC linkers in a primitive cubic lattice and less than about 7.0 wt. % of divalent cation. In an aspect, with washing, and without impregnation of one or more additional cations, there is less than or equal to 5.3 wt. %, or less than or equal to 5.0 wt. % divalent cation as measured by X-ray fluorescence. The zirconium-based metal-organic framework has a relative intensity equal to or greater than 0.35, and/or a peak width ratio of less than 3.0.

A method of making a metal-organic framework comprising the steps of: reacting a precursor metal, a metal complex or a metal oxide (i.e., a first metal source), a polytopic organic carboxylic acid, a second metal precursor metal, a second metal complex or a second metal oxide (i.e., a second metal source), and one or more monocarboxylic acids in a solvent to provide a reaction solution; heating the reaction solution to a reaction temperature of at least 75° C. to provide a reaction mixture comprising a metal-organic framework material; and separating the metal organic framework material from the reaction mixture. The reaction mixture comprises a metal-organic framework material and the metal-organic framework material comprises a plurality of metal-organic frameworks. Each of the plurality of metal-organic frameworks having a plurality of tetravalent cations and terephthalate linkers crystallized in a primitive cubic lattice with about 3.0 wt. % to about 5.0 wt. % of divalent cation and a relative intensity equal to or greater than 0.35.

Further, provided herein are methods of modulating a defect structure or a morphology of a metal organic framework comprising the step of synthesizing the metal organic framework with a secondary metal or secondary metal cations.

In a specific embodiment of the present disclosure, the metal-organic framework may primarily have a REO topology, in particular a REO topology with FCU defects. For instance, the metal-organic framework may correspond to highly defected or even fully defective UiO-66 (as measured by relative intensity which reflects the degree of defects), which may be referred to as REO-UiO-66 family materials. The metal-organic framework of the present disclosure or made by the process of the present disclosure may also be referred to as EMM-71.

These and other features and attributes of the disclosed methods and systems and their advantageous applications and/or uses will be apparent from the detailed description of which follows.

### BRIEF DESCRIPTION OF THE DRAWINGS

To assist those of ordinary skill in the relevant art in making and using the subject matter hereof, reference is made to the appended drawings, wherein:

FIG. 1A1, FIG. 1A2, FIG. 1A3, FIG. 1A4, FIG. 1B and FIG. 1C are powder X-ray diffraction pattern of UiO-66 samples prepared using a traditional synthesis and different Modulator: BDC ratios of four different monocarboxylate modulators.

FIG. 2A1, FIG. 2A2, and FIG. 2A3 show powder X-ray diffraction patterns of UiO-66 samples synthesized with either terephthalic acid, methyl terephthalic acid, and amino terephthalic acid, respectively. FIG. 2B shows a plot of the relative intensity of the samples.

FIG. 3 shows powder X-ray diffraction patterns of samples described in Example 1.

FIG. 4 shows the results of a thermogravimetric analysis of the samples described in Example 1.

FIG. 5A and FIG. 5B are the nitrogen adsorption isotherms of samples 1 and 2 described in Example 1.

FIG. 6 shows X-ray diffraction patterns of Zr-BDC synthesized in the presence of several metal cations.

FIG. 7A & FIG. 7B show powder X-ray diffraction patterns of Zr-MOF samples synthesized with decreasing solution concentrations of acetic acid and increasing reactant concentrations, respectively.

FIG. 8 shows powder X-ray diffraction patterns of samples synthesized from nitrates salts highlighting that no large defect domains form with either cobalt or zinc cations without the presence of chloride ions.

FIG. 9 shows the powder X-ray diffraction pattern of EMM-71 samples made with Zn²⁺ cations.

FIG. 10 shows nitrogen gas adsorption of Zn-BDC samples made in the presence of ZnO and treated with sodium formate post synthesis.

FIG. 11A, FIG. 11B, and FIG. 11C are simulated powder X-ray diffraction patterns of missing node domains with different degrees of residual BDC ligands.

FIG. 12A and FIG. 12B are nitrogen adsorption isotherms of Zn-mediated EMM-71 metal-organic frameworks. In FIG. 12A, the metal-organic frameworks were washed with sodium borate (0.25 M) at pH 9 under different temperature conditions. In FIG. 12B, the metal-organic frameworks were washed with sodium formate (0.5 M) at different time and temperature conditions.

FIG. 13A & FIG. 13B are scanning electron micrographs of EMM-71 metal-organic frameworks synthesized in the presence of zinc (Zn).

FIG. 13C & FIG. 13D are scanning electron micrographs of Zr-BDC metal-organic frameworks synthesized in the presence of cobalt (Co).

FIG. 14 is the powder X-ray diffraction pattern of the metal-organic framework, EMM-71 of Example 2.

FIG. 15 is the powder X-ray diffraction pattern of the metal-organic framework, EMM-71 of Example 3.

FIG. 16 is the powder X-ray diffraction pattern of a metal-organic framework Hf—Zr EMM-71 made with different mole percentages of Hf of total Hf—Zr content in Example 3.

FIG. 17 is the powder X-ray diffraction patterns of the metal-organic framework EMM-71 aliquots taken at 45 minutes, 80 minutes, 120 minutes, 195 minutes, and 255 minutes as described in Example 4.

FIG. 18 is the powder X-ray diffraction pattern of the metal-organic framework, EMM-71 of Example 7.

### DETAILED DESCRIPTION

Before the present compounds, components, compositions, and/or methods are disclosed and described, it is to be understood that unless otherwise indicated this disclosure is not limited to specific compounds, components, compositions, reactants, reaction conditions, ligands, catalyst structures, MOF structures, or the like, as such may vary, unless otherwise specified. It is also to be understood that the terminology used herein is for the purpose of describing particular aspects only and is not intended to be limiting.

Metal-organic frameworks (“MOFs”) are constructed with a three-dimensional assembly of metal ions/metal cluster and organic ligands. Having high pore volumes, ordered structure and tunability, metal-organic frameworks are suitable for use in many applications such as photo catalysis, catalysis, separation and purification, gas/energy storage and sensing. High surface areas and high concentration of isolated metal ions enhances gas storage capacity and mass transportation.

Metal-organic frameworks comprise organic linkers (referred to also as “ligands”) that bridge metal nodes (referred to as “secondary building units” or “SBUs”) through coordination bonds and can self-assemble to form a coordination network. Tunable topologies, either through isoreticular expansion or functionalization of the organic linker/metal node, make metal-organic frameworks customizable for various different applications ranging from catalytic transformations to adsorption and separations to biomedical applications. Metal-organic frameworks have properties useful in industrial applications such as gas adsorption, gas separations, catalysis, heating/cooling, batteries, gas storage, sensing, and environmental remediation.

Stability of a metal-organic framework (“MOF”) can be attributed to strong interactions between ions of low polarizability such as carboxylates and trivalent metals. Stable metal-organic frameworks were initially relegated to phthalate-based MOFs derived from trivalent cations, namely Al³⁺, Fe³⁺, and Cr³⁺. Subsequently, other multivalent cations such as Zr⁴⁺, Hf⁴⁺, or Ti⁴⁺ were utilized to provide additional robust frameworks. A metal-organic framework UiO-66 was first discovered by reacting zirconium salts with linear dicarboxylic acids. Cavka, J. H. et al., A New Zirconium Inorganic Building Brick Forming Metal Organic Frameworks with Exceptional Stability, J. Am. Chem. Soc., 130, 42, 13850-13851, 2008.

At the time of its discovery, UiO-66 had the highest connectivity of any known metal-organic framework.

To enhance adsorption and catalytic properties of metal-organic frameworks, incorporation of defects in MOFs has recently attracted attention. The high degree of connectivity in metal-organic frameworks having high-valent metals such as UiO-66 can provide for a high degree of defects to be generated. In addition to providing flexibility in functionality by selection of a linker, a high degree of connectivity between metal clusters and linkers permits the formation of defects at high concentrations without the collapse of the overall structure. These defects are in the form of either organic linker defects, or as missing node defects, that is the omission of an entire metal cluster. As described herein, under-coordinated metal ions serve as catalytically active sites or anchoring sites for other active elements.

Missing linker defects are due to removal of linkers and generating point defects. Missing node defects or a node defect is created by the coupled removal of the metal clusters and the linkers connected to the metal cluster. The removal of a metal cluster and linkers in a concentrated manner form a nano-domain of REO topology. While both defect types impact mechanical and physical properties of the metal-organic framework, the removal of clusters leaves meso-scale cavities to provide more open hierarchical pore structures that are beneficial for mass and proton transportation.

Control of defect formation is essential in achieving desired properties of the metal-organic framework while maintaining a well-defined and tunable structure. To date, control mechanisms for missing node defects are not at the level of sophistication of missing linker defects. While modulators have been shown useful in controlling missing-linker defects, modulators which can promote the formation of missing-cluster defects are limited, unless excessive concentrations are used. Further, known modulators such as fluorinated carboxylic acids are environmentally undesirable. Moreover, the defect domains are relatively small as evidenced by the broadness of the peaks arising from the defect domains. Relatively speaking, to date, missing-cluster defects are more prominent in systems modulated without monocarboxylates and instead in the presence of water (often with additional hydrochloric acid). Chammingkwan, P. et al., Modulator-free Approach Towards Missing-cluster Defect Formation in Zr-based UiO-66, RSC Adv., Vol. 10, 28180-28185, 2020.

Provided herein are methods of synthesizing zirconium terephthalate metal-organic frameworks in FCU topology (cuboctahedron edge transitive nets of cluster-based MOF) that contain controllable domain sizes of missing-cluster defects (referred to herein as “node defects”) through the incorporation of divalent metal cations, and, primarily metal-organic frameworks having REO topology with FCU defects. The present methods make novel metal-organic frameworks having node defects. The utility of node defects in both adsorption and catalytic applications is considerable. For example, for grafted catalytic sites, the defects can be capped with catalytic moieties that provide additional functionality. With regards to separation applications, selective binding of multi-ring naphthene can occur, particularly at larger defects to provide enhanced selectivity for multi-ring naphthene separation (in addition to enhanced diffusional characteristics).

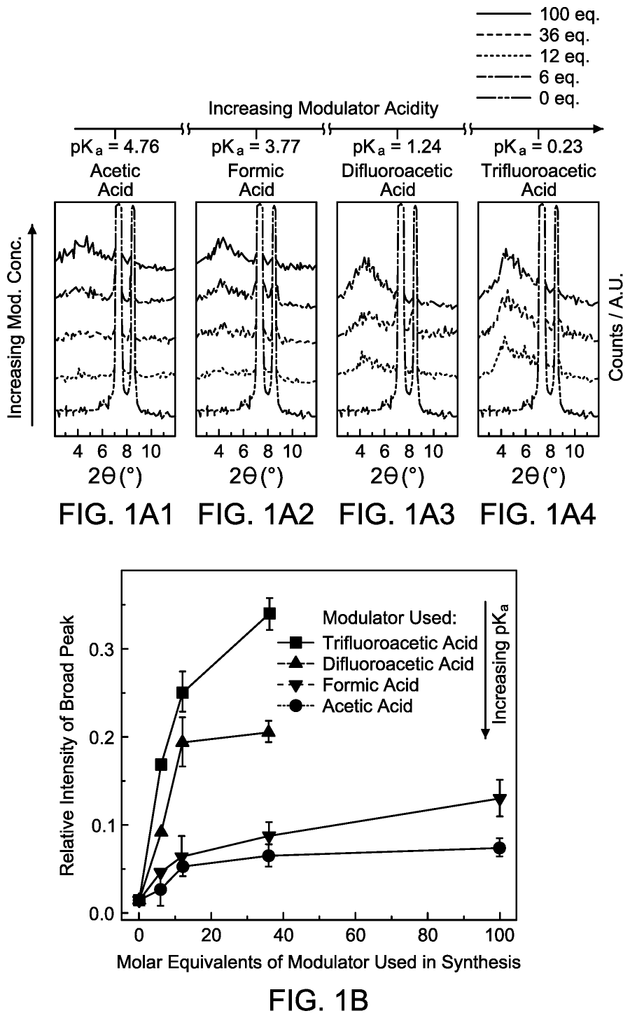

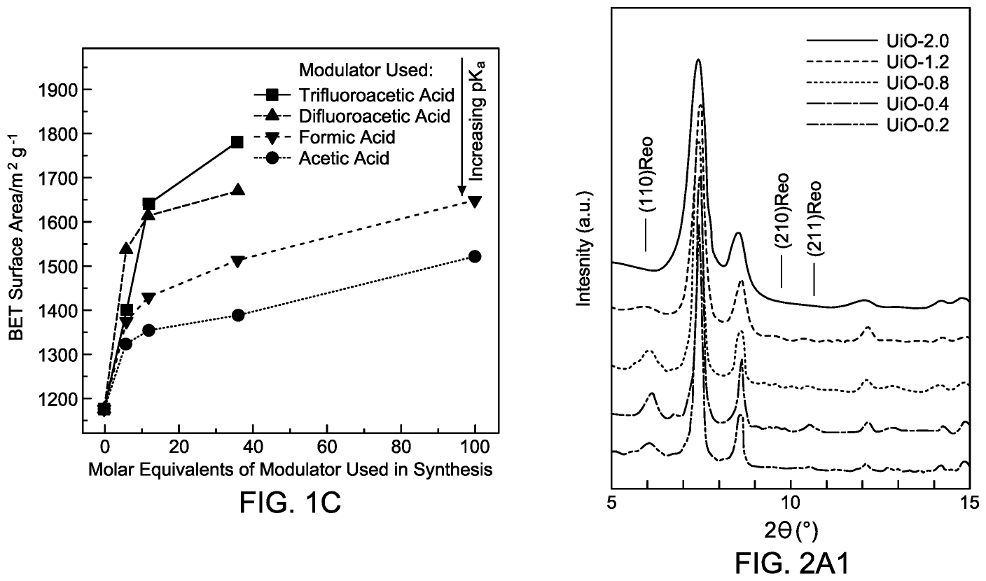

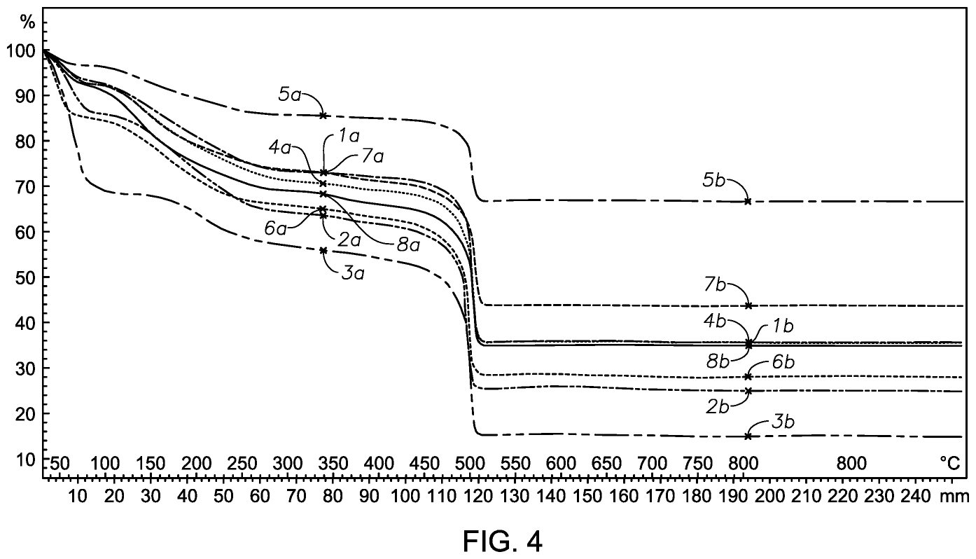

As used herein, the term “REO topology” refers to the cube transitive nets or a topological net of Zr-MOFs as described by Chen et al., Reticular Chemistry in the Rational Synthesis of Functional Zirconium Cluster-base MOFs, Coordination Chemistry Reviews, 400, 2019; See e.g., Chen, et al., supra, FIG. 1 and FIG. 4.

As used herein, the term “divalent” refers to an oxidation state of the divalent cation and not whether it is part of an overall charged molecule (for example, ZnCl₂ dissolved and not dissociated).

As described herein, the present metal-organic frameworks have a surface area between about 1100 m²/g and 2700 m²/g, a porosity of between about 0.45 cc/g and 1.1 cc/g, and a relative intensity equal to or greater than 0.35. In an aspect, these metal-organic frameworks have a relative ratio of peak width at half maximum of less than 3. The relative ratio of peak width at half maximum is equal to the width of the (110) peak at half of its height divided by the width of the (111) peak at half of its height. In addition, as described herein, the present methods of making defective metal-organic frameworks produces a metal-organic framework having divalent cation in an amount of less than or equal to 5.0 wt. %, such as about 3.0 wt. % to about 5.0 wt. % in the as-made material.

In a traditional synthesis of producing zirconium MOFs of the FCU topology, a linear bidentate ligand is dissolved in a polar aprotic solvent, typically dimethylformamide, with a source of zirconium (i.e., zirconyl chloride or zirconium tetrachloride) and a modulator. The modulator can be monocarboxylic acids such as formic, acetic, benzoic, or trifluoroacetic acid, but can also be water or hydrochloric acid. For example, as shown in FIG. 1A1, FIG. 1A2, FIG. 1A3, FIG. 1A4, FIG. 1B and FIG. 1C (collectively referred to as FIG. 1), powder X-ray diffraction patterns of UiO-66 samples were prepared with a traditional synthesis and using different Modulator:BDC (benzene dicarboxylate) ratios for four different monocarboxylate modulators. See, Shearer, G. C. et al., Defect Engineering: Tuning the Porosity and Composition of the Metal-Organic Framework UiO-66 via modulated Synthesis, Chem. Mater., 28, 11, 3749-3761, 2016. The feature centered around 5° 2θ represents the nanoscopic domains of missing node defects (also referred to herein as “REO defects”). As shown in FIG. 1B, relative intensity of this feature (which is the integrated intensity of the feature (centered around 5° 2θ) divided by the average of the intensity of the (111), (200), and (600) peaks) plotted against the molar equivalents of modulator used. As shown in FIG. 1C, a plot of modulator concentration versus the measured surface area of the resulting materials is provided. In the work shown, missing-clusters/node defects appear as a broad feature that is not well defined that spans from ˜3-7° 2θ. This is the result of symmetry forbidden peaks occurring due to defect domains. Here, the node defect forms a primitive cubic lattice with no systematic absences while the perfect single crystal is of a face centered cubic domain which only shows reflections of all add or all even domains. In a subsequent report, Lillerud demonstrated that HCl modulation (in lieu of a carboxylic acid modulator) more pronounced diffraction peaks associated with a node defect. See, Shearer, et al., Functionalizing the Defects: Postsynthetic Ligand Exchange in the Metal-Organic Framework UiO-66, Chem. Mater., 28, 20, 7190-7193, 2016.

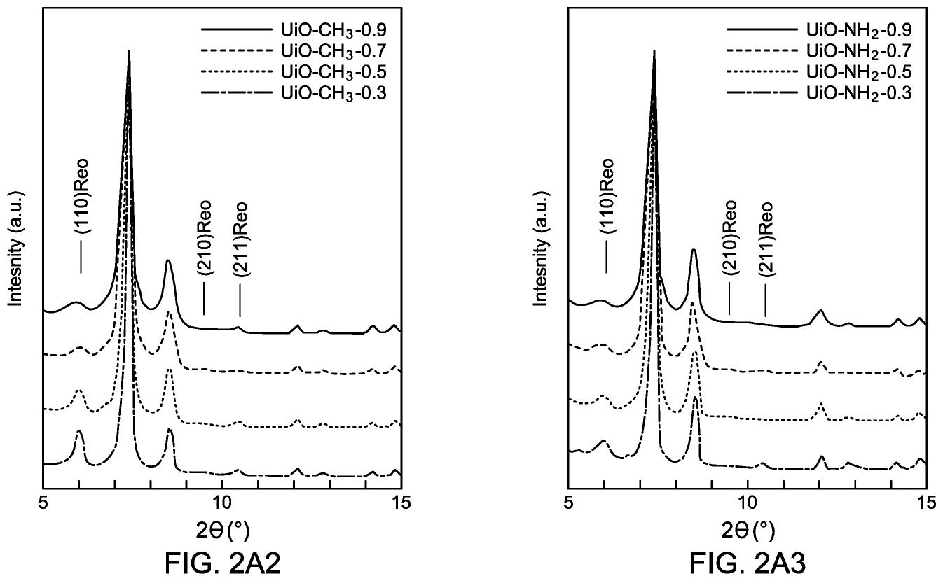

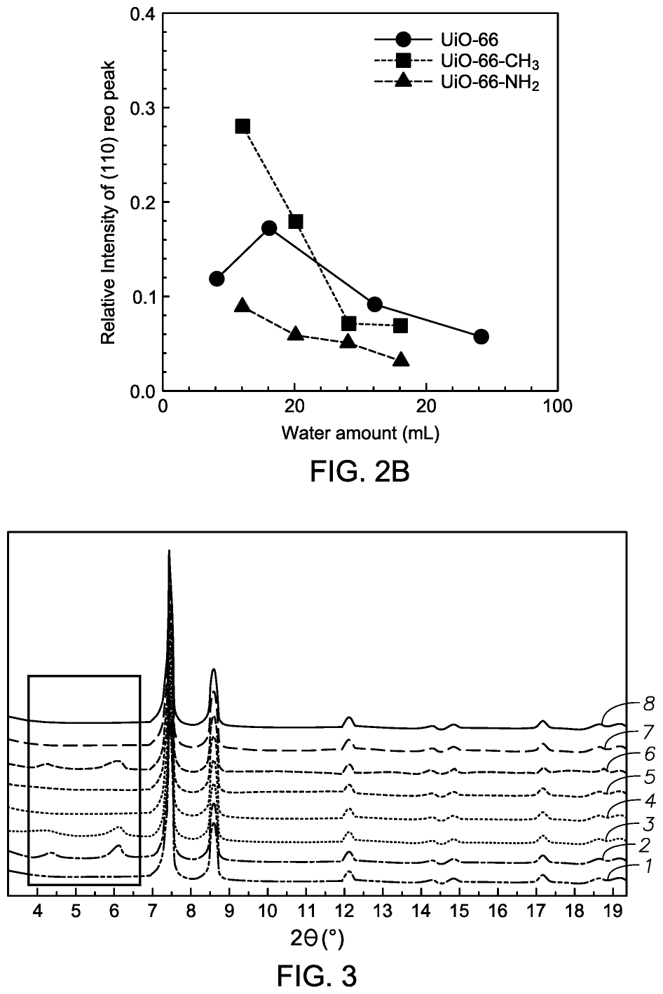

Building on these earlier reports, Chammingkwan et. al., supra, demonstrated that water could effectively generate these defects when very low water content was used to synthesis node-defected UiO-66 as well as methyl and amino-functionalized analogues. In all cases where less than 0.5 mL of water was added, equating to a H₂O:Zr ratio of 14, modest domains of missing node defects are observed. In all cases, the degree of defects is characterized by comparing the integrated intensity of the broad defect region (in this case the (110) peak) and dividing this integrated value by the average of the intensities of the (111), (200), and (600) reflections. FIG. 2A1, FIG. 2A2, and FIG. 2A3 show the XRD patterns of unfunctionalized and functionalized UiO-66 and FIG. 2B plots “relative intensity” of (110) REO peaks using the Chammingkwan et al. method (which refers to Shearer et al. supra). Even in the most extreme of cases, the intensity of the (110) peak relative to the average of the (111), (200), and (600) peaks is only approximately 0.18, in the case of unfunctionalized UiO-66.

Unlike in the earlier methods of creating missing node defects described above, we disclose missing-cluster/node defects produced more effectively than previously known. As described herein, we show that inclusion of select divalent metals, not only induce the node defect, but select divalent metals can induce the generation of missing clusters at a much higher degree than prior art methodologies.

In our investigations, Sn had a ratio of peak widths of 3:1 which as used herein, means a ratio of peak widths at the (110) peak (from the REO defects) were 3 times as wide at their half height as compared to the (111) peak. Zirconium and cobalt can produce a ratio that is smaller, i.e., 1.7 to 1.2. Therefore, the present metal-organic frameworks can have a ratio of peak widths at half maximum of the (110) and (111) peaks less than 3, less than 2.5, less than 2, less than 1.75, less than 1.50, or even less than 1.25.

As described in the examples, we first investigated whether divalent ions can incorporate into a metal-organic framework structure after in situ oxidation. While incorporation of divalent ion was not observed to any large degree, we observed the presence of exaggerated diffraction reflections corresponding to the (100) and (110) planes of the REO topology. Similarly other divalent ions such as magnesium, calcium, and nickel did not produce these same reflections, indicating the lack of missing node defects. Mono-cationic metals such as lithium also did not produce the desired reflections. Moreover, resulting micropore volumes were less than might be expected given the intensity of the peaks.

Under identical synthetic conditions described herein, copper (II) chloride showed some amount of REO domains, comparable to that of metal-organic frameworks produced from stannous chloride. On the other hand, intense reflections were observed with cobalt and zinc chloride for the (100) and (110) peaks of the REO domains as well as the (210) and (211) reflections, rarely observed in this family of metal-organic frameworks. Magnesium, lithium, and nickel (2+) showed limited to non-existent diffraction intensity between 4-6° 2θ.

Beyond the unexpected role of select divalent cations on missing-node defect formation, we further observed that the efficacy of the cation can be dependent on the presence halide cations in solution. For example, use of only nitrate salts (zirconyl nitrate and cobalt/zinc nitrate) did not provide defect formation and the process was reversible through the addition of either HCl or NH₄Cl. While NH₄Br can be effective, oxidation of the bromide anion to elemental bromine can interfere in this process. Fluoride, conversely, causes the formation of alternative phases and the metal organic framework will not form with the addition of ammonium fluoride.

In addition, only modest amounts of chloride might be required to actuate a REO-generating mechanism, or the transition from FCU topology to REO topology. Non-halide metal modulators such as zinc oxide (as well as zinc metals as divalent zinc sources) effectively generates a transition from FCU topology to REO topology and the REO domains. In the case of zinc oxide, it appears that oxide reacts with acetic acid in the reaction to form zinc acetate and water. However, zinc metal will generate flammable gas and zinc oxide can affect the acid/base properties of the solution.

Defect-generating cations, measured as M:Zr (or more generally as divalent cation:tetravalent cation), appear to be optimal at approximately 37 wt. %. Lower, ratios of approximately 25 wt. % divalent cation can be effective in generating REO defects (referred to as missing-clusters or node defects in a REO topology), especially when measured by powder X-ray diffraction (“PXRD”). Further it appears that porosity is easier to maximize at the slightly higher value. When divalent cation content dropped to about 10 wt. % relative to zirconium (or more generally to tetravalent cation), attenuated peaks can be observed. When CoCl₂ is used as a modulator, an upper effective cobalt concentration was not observed. ZnO, however did exhibit an upper bound which may be due to either the generation of water equivalents or acetate equivalents that interfere with domain formation of REO topology. Excess acetate and high pH can affect the solution processes that provide missing-node defects.

Combined, a complicated solution state process occurs prior to nucleation and growth and the presence of these select divalent cations perturb the kinetics of these processes giving rise to node defects. This is indicated by the loss of defects if the inorganic components are presaged. If a ligand is added shortly after adding the inorganic reagents to the reaction mixture, the defects appear. As dwell time increases, reflections of the REO topology and associated REO domains are attenuated. For example, after four (4) hours, no defects might form suggesting that the additive can retard the formation of certain chemical species in solution which beget FCU domains of the metal-organic framework. Moreover, in addition to the halide concentration, other variables can influence the degree of defects of the resulting metal-organic framework materials including (1) acetic acid concentration, (2) water content, (3) reaction temperature, (4) metal/ligand ratio, and (5) divalent dopant content.

Further, the amount of acetic acid in the reaction medium can impact the intensity of reflections of the REO domains in a REO topology in PXRD. For example, when HOAc:BDC is lowered and overall concentration of acetic acid is maintained, missing node defects can be maintained until reactant concentrations reached a critical level. This is possibly due to increasing concentration of water in the reaction and evinces the importance of not only the molecular ratios of these molecular species, but also solution concentrations of these reactant species. While water forms zirconium secondary building units, a tension forms as overly high concentration can result in a decrease in defect density, requiring an upper bound for reaction concentration. Further, when using hydrated salts, beyond a certain reaction concentration, high yield and high defect concentrations are not produced regardless of water concentration. This can be ameliorated through the use of anhydrous salts such as ZrCl₄, or by slowly adding zirconium to the reaction medium. For characterizing nanoscale materials, powder X-ray diffraction is described in an editorial published by the American Chemical Society, Holder, C. F. et al., Tutorial on Powder X-ray Diffraction for Characterizing Nanoscale Materials, ACS Nano, 13, 7, 7359-7365, 2019.

In addition to acetic acid and water, we also observed that temperature was as a potent variable in the synthesis of node-defected metal-organic framework. Like Lillerud's observation in his 2014 publication, high temperature reaction conditions tend to produce low defect-containing materials. See, Shearer, et al., Tuned to Perfection: Ironing Out the Defects in Metal-Organic Framework UiO-66, Chem. Mater., 26, 14, 4068-4071, 2014. In that particular work, reaction conditions were screened between 100° C. and 220° C., with materials synthesized at 220° C. having nearly no defects. In the case of metal-organic frameworks having REO topology, temperature dependence is accentuated. Reactions conducted between 80° C. and 130° C. were conducted and it was observed that high levels of defects only dominated the PXRD when reactions were conducted between 90° C. and 100° C. Below this temperature, large amounts of unreacted BDC were present and above these temperatures, attenuated reflections of the REO domains occurred.

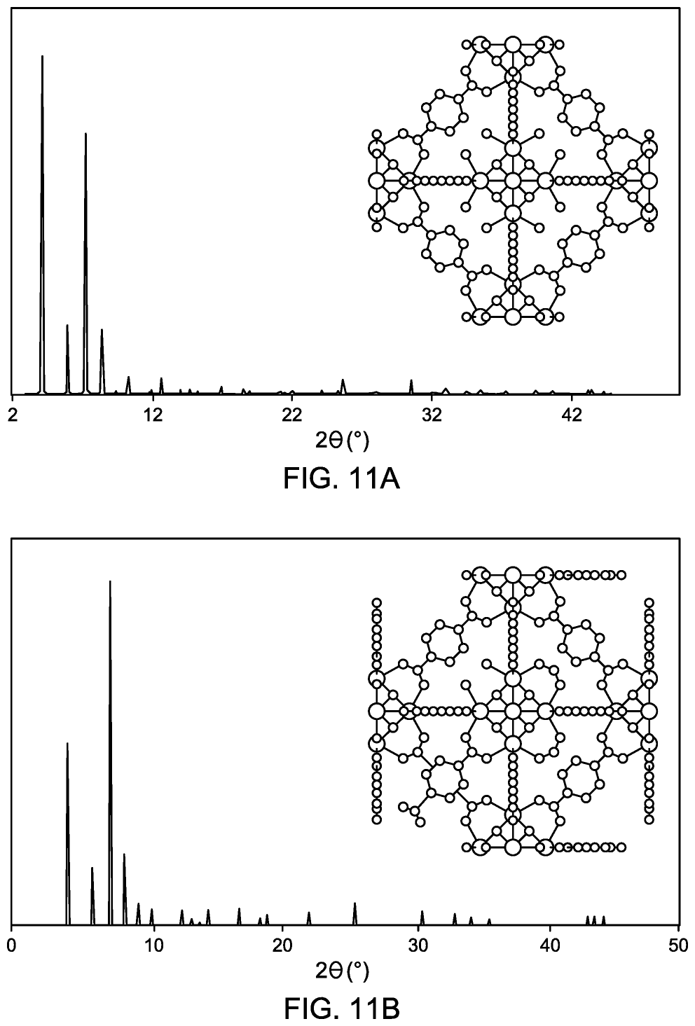

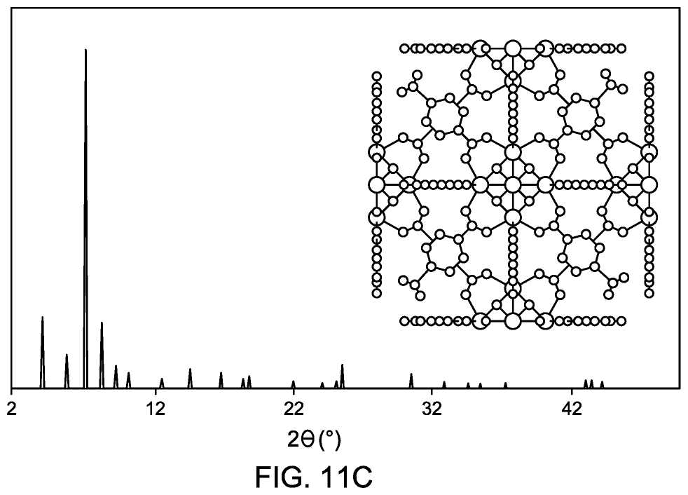

With such intense reflections of the REO domains, we endeavored to gauge the overall contribution of the defect domains compared to the non-defected FCU domains. Towards this end, we constructed material studio models with missing nodes with various amounts of organic ligand flanking defect sites. We then compared relative intensities of the (100), (110), (111), and (200) reflections with these models. As shown in FIG. 11A & FIG. 11B, a completely defective material in which each defect is capped with either a hydroxyl or a water moiety, results in a pattern where the (100) reflection peak is the predominant feature in the diffraction pattern. This is in stark contrast to what is observed in the experimental materials that exhibit a ratio of 1:1.56:2.7 between the (100), (110), and (111) reflection peaks. When comparing the experimental diffraction patterns to the model-derived patterns, the relative intensity is similar to materials containing pendant BDC. This is consistent with the thermal analysis of the samples which exhibited more organic content than would be expected from the experimental formula for the metal-organic framework, EMM-71 of Zr₆O₄(OH)₄BDC₄.

The presence of secondary organic ligands is supported by evaluating the thermal analysis of as-made materials. Assuming the residue weight at 600° C. is purely ZrO₂, we can estimate the predicted weight for a fully hydrolyzed structure (where all Zr-sites are capped with a water and hydroxyl when not coordinated to a BDC linker) with a chemical formula of Zr₆O₄(OH)₈(H₂O)₄(BDC)₄. These materials exhibit excess organic weight loss, consistent with the presence of pendant organic ligands. Nitrogen gas adsorption showed a relatively low micropore volume than what would be expected for a material with such high degrees of node defects.

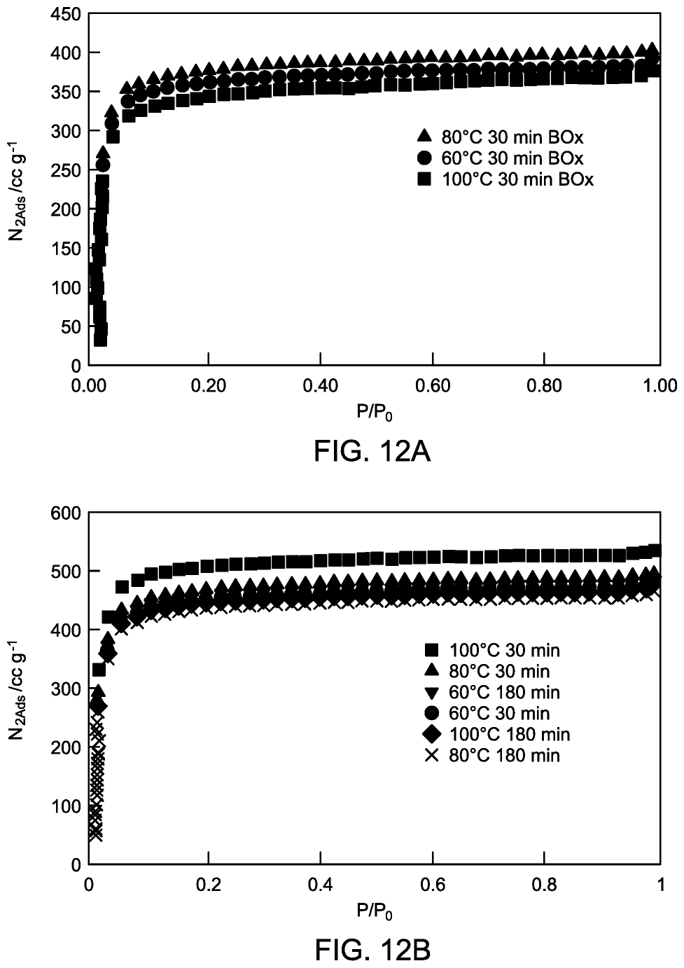

To remove pendant ligands and realize pore volumes indicative of a structure having defects, defective MOF can be washed in slightly basic solutions. For example, sodium borate, a weakly interacting anion (as opposed to phosphate or carbonate) and buffers at the modest pH of 9 can be used to wash the MOF and significant decrease in peak intensity may be observed. To moderate the damaging effects of the borate solutions, we attempted the washing procedure at lower temperatures and at lower borate concentrations. In all cases, an increase in the (100) reflection relative to the (111) reflection indicative of the loss of pendant ligands may be observed. In the thermal analysis of samples, less organic weight loss might be observed. Gas adsorption measurements show moderate increases in the adsorption capacity when 0.25 M NaBOₓ solution is used at temperatures of respectively 100° C., 60° C. and 80° C. FIG. 12A. More concentrated solutions can provide a decrease in surface area, presumably due to the degradation of the framework.

In addition to weakly interacting anions such as borate, we tested the efficacy of formate solutions in removing these pendant ligands. While it was expected that borate solutions might result in hydroxylated zirconium cites, formate can exchange with pendant dangling ligands and leave formate-capped defect sites. Towards this end, samples washed with sodium formate using somewhat analogues conditions to that of the borate washed samples can have a thermal analysis is in line with samples that are comprised of predominantly formate capping groups. FIG. 10. The powder X-ray diffraction should exhibit the characteristic increase in the (100) and (110) reflection intensity relative to the (111) that we ascribe to the generation of a more open framework. FIG. 11A show a REO domain with no excess BDC ligands. FIG. 11B shows that one third of available REO domains are capped with excess BDC ligands. FIG. 11C shows all available sites capped with excess BDC ligands.

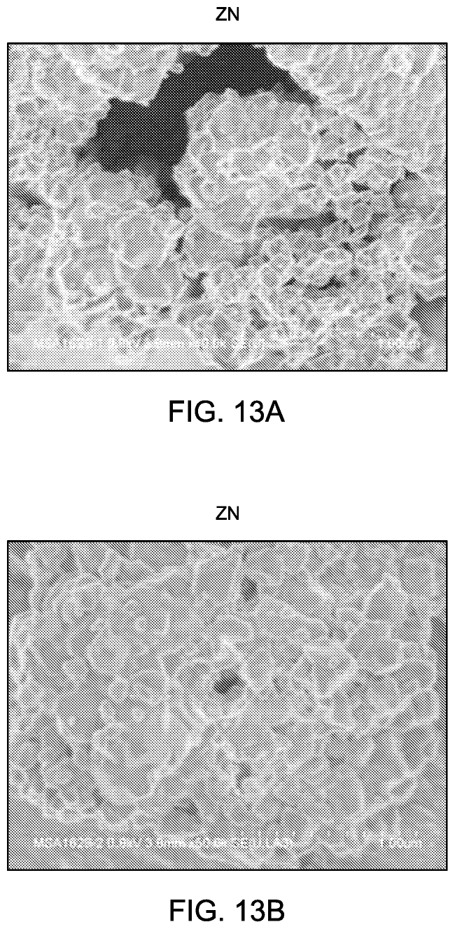

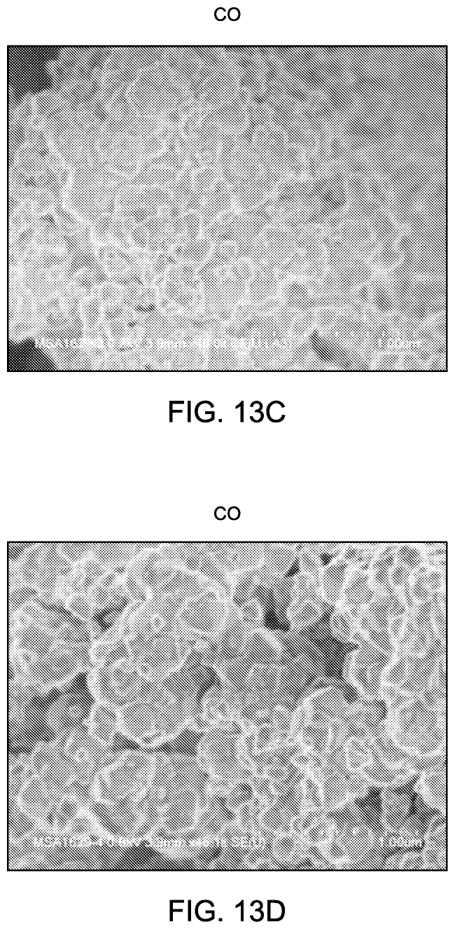

The adsorption studies conducted on formate washed material have shown an increase in the measured micropore volume and surface area. These results, however represent a non-optimized washing procedure. The removal of pendant ligands is concomitant with structural degradation resulting from the high temperature, high pH conditions. We probed the effect of washing temperature and time by running this washing procedure with 0.5 M sodium formate at 60° C., 80° C. and 100° C. and at time of either 30 minutes or 180 minutes. The most optimal washing condition requires a short contact time of sodium formate at 100° C. As shown in FIG. 12B, a 10 to 20% increase in micropore volume from the least to most optimal washing conditions is observed. In all cases, a relatively flat plateau region from 0.2-0.95 P/P₀ indicative of low textural porosity and larger crystal sizes. Indeed, SEM micrographs of materials obtained from this synthesis shows large polycrystalline aggregates reminiscent of early non-mediated MOF materials. FIG. 13A, FIG. 13B, FIG. 13C & FIG. 13D. This does not appear necessarily due to the presence of the divalent modifier as control reactions without their presence exhibit the same particle morphology. It is more likely due to the relatively high concentrations of the synthesis.

Provided herein are metal-organic frameworks comprising a plurality of tetravalent cations and terephthalate linkers crystallized in a primitive cubic lattice and having a surface area between about 1100 m²/g and 2700 m²/g, a porosity of between about 0.45 cc/g and 1.1 cc/g, and a relative intensity equal to or greater than 0.35. In an aspect, the tetravalent cation is a tetravalent metal cation and is selected from Zr, Ti, Hf and/or Ce, e.g., Zr or a mixture of Zr and Hf. In an aspect, the terephthalate linker is selected from 1,4-benzenedicarboxylate (BDC) or derivative thereof, e.g., 2-amino-1,4-benzene dicarboxylic acid (2-amino-1,4-benzene dicarboxylate), 1,2,4-benzene tricarboxylic acid (1,2,4-benzene tricarboxylate), 1,3,5-benzene tricarboxylic acid (trimesic acid) (1,3,5-benzene tricarboxylate), 1,2,4,5-benzene tetracarboxylic acid (1,2,4,5-benzene tetracarboxylate), 2-nitro-1,4,-benzene dicarboxylic acid (2-nitro-1,4,-benzene dicarboxylate), 2-chloro-1,4-benzene dicarboxylic acid (2-chloro-1,4-benzene dicarboxylate), 2-bromo-1,4-benzene dicarboxylic acid (2-bromo-1,4-benzene dicarboxylate), and mixtures thereof. In an aspect, the metal-organic framework further comprises about between about 0.0 wt. % and 10.0 wt. % divalent cation, e.g., divalent metal cation, such as Zn, Co, Sn and/or Cu.

More specifically, the metal-organic framework can comprise a plurality of zirconium cations and a plurality of BDC linkers in a primitive cubic lattice, and between about 0.0 wt. % to 10.0 wt. % of divalent cation. The metal-organic framework has a surface area as measured by nitrogen BET of between about 1100 m²/g and 2700 m²/g, a porosity of between about 0.45 cc/g and 1.1 cc/g, and a relative intensity equal to or greater than 0.35 and/or a peak width ratio of less than 3.0.

In an aspect, the metal-organic framework can be characterized by the first five diffraction peaks with d spacings at 20.4130, 14.4691, 11.8446, and 10.2594 Å±5% and comprises a primitive cubic cell unit. In an aspect, the metal-organic framework has a peak width ratio (peak width at half maximum between the (110) and (111) reflections) less than 3.

According to an embodiment of the invention, the metal-organic framework is made by a process comprising the steps of reacting a first metal source that can generate a tetravalent metal cation in solution, a polytopic organic carboxylic acid (i.e., a molecule that can bind two sites, e.g., a linear dicarboxylic acid such as 1,4-benzenedicarboxylic acid or derivative thereof), a second metal source that can generate a divalent cation in solution, and one or more monocarboxylic acid(s) modulator(s) in a solvent to provide a reaction solution, and heating the reaction solution to provide a reaction mixture that comprises the metal-organic framework, e.g., a metal-organic framework that comprises between a trace amount (0 wt. %) to about 10 wt. % of divalent cation, and having a surface area between about 1100 m²/g and 2700 m²/g, a porosity of between about 0.45 cc/g and 1.1 cc/g, and a relative intensity equal to or greater than 0.35 and/or a peak ratio of the (110)/(111) widths less than 3.

In a further embodiment, the present invention relates to a method of making a metal-organic framework comprising the steps of: reacting a first metal source that can generate a tetravalent metal cation in solution (e.g., in the form of a metal precursor, a metal complex or a metal oxide), a polytopic organic carboxylic acid that can generate terephthalate linkers, a second metal source that can generate a divalent cation in solution (e.g., in the form of a metal precursor, a metal complex or a metal oxide), and one or more monocarboxylic acids in a solvent to provide a reaction solution; heating the reaction solution to a reaction temperature of at least 75° C. to provide a reaction mixture; and separating the metal organic framework material from the reaction mixture.

In an aspect, the first metal is selected from Zr, Ti, Hf and/or Ce, e.g., Zr or a combination of Zr and Hf. The first metal source may be in any suitable form, such as in the form of a metal precursor, a metal complex or a metal oxide, for instance in the form of metal chlorides, oxychlorides, nitrates, oxynitrates, or oxides.

In an aspect, the second metal is chosen from Zn, Co, Sn, Cu, and mixtures thereof. The second metal source may be in any suitable form, such as in the form a metal precursor, a metal complex or a metal oxide, for instance in the form of metal chlorides, oxychlorides, nitrates, oxynitrates, or oxides.

In an aspect, the polytopic organic carboxylic acid is selected from an aromatic di, tri or tetracarboxylic acids that can generate terephthalate linkers. In an aspect, the polytopic organic carboxylic acid is functionalized, e.g., by an alkyl, halo, nitro, cyano, amino, sulfonyl, thio, isocyano, alcoxy, ether, ester, or carboxylate group. Suitable examples of polytopic organic carboxylic acid include 1,4-benzenedicarboxylic acid (terephthalic acid) or derivatives thereof, 2-amino-1,4-benzene dicarboxylic acid, 1,2,4-benzene tricarboxylic acid (trimellitic acid), 1,3,5-benzene tricarboxylic acid (trimesic acid), 1,2,4,5-benzene tetracarboxylic acid, 2-nitro-1,4,-benzene dicarboxylic acid, 2-chloro-1,4-benzene dicarboxylic acid, 2-bromo-1,4-benzene dicarboxylic acid, and mixtures thereof, especially suitable examples being terephtalic acid or trimesic acid.

In an aspect, the monocarboxylic acid(s) is selected from any monocarboxylic acid traditionally used as modulator in the synthesis of MOFs, in particular of zirconium MOFs of the FCU topology, for instance formic, acetic, benzoic, difluoroacetic or trifluoroacetic acid. In a further aspect, the monocarboxylic acid concentration is between about 30 volume % and 70 volume % of the total volume of solvent (the total volume of solvent being calculated as the total amount of monocarboxylic acid(s), organic solvent(s) and optional water present in the reaction solution).

In an aspect, the solvent is selected from any organic solvent traditionally used as a solvent in the synthesis of MOFs, in particular of zirconium MOFs of the FCU topology, typically a polar aprotic solvent, for instance dimethylformamide (DMF). Without wishing to be bound by theory, it is believed that the solvent, in particular DMF, may cause the second metal (or divalent cation) to have unique coordination environment which might play a role in its effectiveness in providing metal-organic frameworks according to the present invention.

In an aspect, the tetravalent cation to linker (in particular to terephthalate linker) mol ratio is between about 1.75:1 and about 1:1.75.

In an aspect, the divalent cation to tetravalent cation mol ratio is from about 0 to about 5, for instance up to 2 or up to 1, such as up to 0.5, and/or at least 0.05, or at least 0.1, such as at least 0.15.

In an aspect, the reaction solution further comprises water in a concentration between about 0 moles and 5 moles per liter of the total reaction volume.

In an aspect, the reaction solution further comprises one or more of F, Cl, Br or I ions, in particular Cl. Such halides may be introduced via the first and/or second metal source. Suitable sources of such halide ions also include corresponding ammoniums halides, HCl, HF, HBr and HI. In an aspect, the halide(s) may be present in any suitable amount, for instance up to 4.7:1 Cl:Zr mol ratio and 13:1 Cl:M²⁺ mol ratio when using 35 mol % M:Zr with the M source being MCl₂ and the Zr source being ZrCl₄.

In an aspect, the reaction solution is heated to a reaction temperature of less than 200° C., in particular less than 160° C. or less than 150° C., more particularly less than 140° C., such as between 80° C. and 130° C., for instance between 90° C. and 100° C. Separating the metal organic framework material from the reaction mixture can be conducted by standard means, such as via centrifugation or filtration.

The present method may further comprise washing the metal-organic framework material separated from the reaction mixture by any standard means. For instance, the metal-organic framework material may be washed by a solvent such as DMF, methanol, ethanol, acetone and/or water, e.g., to remove excess organic ligand. The metal-organic framework material may also be washed in slightly basic solutions, for instance borate or formate solutions, such as boron borate or boron formate, to remove pendant ligands.

The reaction mixture comprises a metal-organic framework material and the metal-organic framework material comprises a plurality of metal-organic frameworks. In a specific aspect, each of the plurality of metal-organic frameworks has a plurality of tetravalent cations and terephthalate linkers crystallized in a primitive cubic lattice, with less than about 5.0 wt. % of divalent cation, such as about 3.0 wt. % to about 5.0 wt. % in the as-made material, and a relative intensity equal to or greater than 0.35.

In a specific aspect, the metal organic frameworks made by the methods described herein may therefore include a plurality of zirconium cations and BDC linkers in a primitive cubic lattice and less than about 5.0 wt. % of divalent cation, such as about 3.0 wt. % to about 5.0 wt. % in the as-made material. The zirconium-based metal-organic framework has a relative intensity equal to or greater than 0.35.

Further, provided herein are methods of modulating a defect structure or a morphology of a metal organic framework, in particular of MOFs crystallized in a primitive cubic lattice, such as MOFs of the FCU topology (e.g., zirconium MOFs of the FCU topology, such as UiO-66) comprising the step of synthesizing the metal organic framework in the presence of a secondary metal or secondary metal cations. In an aspect, the metal organic framework comprises a first metal that has a different valence than the secondary metal or secondary metal cations, in particular the metal or first metal being a tetravalent metal or tetravalent metal cations (e.g., Zr, Ti, Hf and/or, Ce) and the secondary metal or secondary metal cations being a divalent metal or divalent metal cations (e.g., Zn, Co, Sn and/or Cu). This method may for instance be applied to metal organic framework comprising a plurality of tetravalent cations, in particular a plurality of zirconium cations, and terephthalate linkers crystallized in a primitive cubic lattice.

In an embodiment of the various aspects of the present invention, the metal-organic framework primarily has a REO topology, in particular a REO topology with FCU defects. For instance, the metal-organic framework may correspond to highly defected or even fully defective UiO-66 (as measured by relative intensity which reflects the degree of defects), which may be referred to as REO-UiO-66 family materials. Said highly defected/fully defective frameworks, as disclosed in the present application or made by the process of the present application, may be referred to as EMM-71.

In further specific embodiments of the various aspects of the present invention, the metal-organic frameworks have at least one of a surface area of at least about 1400 or at least about 1600 m²/g and/or of at most about 2400 or at most about 2200 m²/g; a porosity of at least about 0.55 cc/g and/or of at most about 0.75 cc/g; a relative intensity of at least 0.45, or at least 0.55, or at least 0.65, such as at least 0.75 or even at least 1.0; and/or a peak width ratio of less than 2.9, or less than 2.8, or less than 2.7, such as less than 2.5, less than 2.0, less than 1.75, or even less than 1.5 or less than 1.25, for instance as low as 1.2 or even lower.

In the various aspects of the present invention, cubic structure or cubic lattice type refers to cubic Bravais structure or cubic Bravais lattice type.

Aspects of the disclosure are described in greater detail by way of specific examples. The following examples are offered for illustrative purposes, and are not intended to limit the disclosure in any manner. Those of skill in the relevant art will readily recognize a variety of parameters can be changed or modified to yield essentially the same results. The following non-limiting examples are provided to illustrate the disclosure.

### Examples

In these examples, the X-ray diffraction (XRD) patterns of the materials were recorded on an X-Ray Powder Diffractometer (Bruker D8 Envdevor instrument) in continuous mode using a Cu Kα radiation, Bragg-Bentano geometry with Lynxeye detector, in the 20 range of 2 to 60°. The interplanar spacings, d-spacings, were calculated in Angstrom units. The intensities are uncorrected for Lorentz and polarization effects. The location of the diffraction peaks in 2-theta, and the relative peak area intensities of the lines, I/I(o), where Io is the intensity of the strongest line, above background, were determined with the MDI Jade peak fitting algorithm using a 3^{rd} order polynomial background fit. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history.

The relative intensity is measured by the method of Shearer, G. C. et al., Defect Engineering: Tuning the Porosity and Composition of the Metal-Organic Framework UiO-66 via modulated Synthesis, Chem. Mater., 28, 11, 3749-3761, 2016. Relative intensity is characteristic of the degree of defects, in particular of node defects, in the framework. As detailed in Shearer et al., relative intensity of the broad peak (i.e., between 3 and 7° 2θ) is a quantitative descriptor for the concentration of missing cluster defects in the framework, e.g., in the UiO-66 framework. Relative intensity is calculated as the integrated intensity of the broad peak (around 5° 2θ, such as between 2 and 7° 2θ, i.e., corresponding to the aggregate integrated intensity of the (100) and (110) peaks in the present invention) divided by the average of the intensity of the (111), (200), and (600) peaks which corresponds respectively to peaks at about 7.4, 8.5 and 25.8° 2θ.

$$Relative Intensity = \frac{I ( broad peak )}{[ ( I ( 111 ) + I ( 200 ) + I ( 600 ) ) / 3 ]}$$

The peak width ratio is the ratio between the calculated peak width at half maximum (as calculated by the MDI Jade peak fitting algorithm) of the (110) peak and the (111) peak occurring at ˜6 and 7.4° 2θ.

The scanning electron microscopy (SEM) images of the as-synthesized materials were obtained on a Hitachi 4800 Scanning Electron Microscope.

The surface area (S_{BET}) of the materials was determined by the BET method as described by S. Brunauer, P. H. Emmett and E. Teller, J. Am. Chem. Soc., 1938, 60, 309, incorporated herein by reference, using nitrogen adsorption-desorption at liquid nitrogen temperature.

The porosity (or micropore volume) of the materials can be determined using methods known in the relevant art. For example, the porosity of the materials can be measured with nitrogen physisorption, and the data can be analyzed by the t-plot method described in Lippens, B. C. et al., “Studies on pore system in catalysts: V. The t method”, J. Catal., 4, 319 (1965), which describes micropore volume method and is incorporated herein by reference.

Thermogravimetric analysis (TGA) was performed on the materials by heating in air from room temperature to 850° C.

### Example 1: Use of SnCl₂ to Induce REO Defects in the Structure of EMM-71

Terephthalic acid, zirconyl chloride octahydrate, tin dichloride dehydrate, dimethyl formamide, and acetic acid (as per table 1) were charged into a 20 cubic centimeter (“cc”) vial and heated for between 16-20 hours with magnetic stirring. The reactants used for eight (8) samples were as follows.

TABLE 1
Reaction Materials

| | | ZrOCl₂•8 | | | | | | | | | |
|---|---|---|---|---|---|---|---|---|---|---|---|
| | BDC | H₂O | SnCl₂•2H₂O | DMF | HOAc | Temp | | | | Peak | Relative |
| Sample | (mg) | (mg) | (mg) | (mL) | (mL) | (° C.) | BDC:Mₜₒₜ* | Zr:Sn* | HOAc:L* | Ratio | Intensity |
| 1 | 441 | 492 | 131 | 5 | 3 | 100 | 1.259 | 0.381 | 19.4 | 3.8 | 0.214 |
| 2 | 441 | 492 | 131 | 5 | 4 | 100 | 1.259 | 0.381 | 25.9 | 2.6 | 0.44 |
| 3 | 441 | 492 | 131 | 5 | 5 | 100 | 1.259 | 0.381 | 32.4 | 1.8 | 0.92 |
| 4 | 350 | 492 | 131 | 5 | 2.5 | 100 | 0.999 | 0.381 | 20.4 | 4.6 | 0.12 |
| 5 | 350 | 492 | 131 | 5 | 0 | 100 | 0.999 | 0.381 | 24.5 | 2.8 | 0.05 |
| 6 | 350 | 492 | 131 | 5 | 4 | 100 | 0.999 | 0.381 | 32.7 | 4.9 | 0.59 |
| 7 | 260 | 492 | 131 | 5 | 1.75 | 100 | 0.742 | 0.381 | 19.2 | N/A | N/A |
| 8 | 260 | 492 | 131 | 5 | 2.3 | 100 | 0.742 | 0.381 | 25.3 | N/A | N/A |

*Molar ratios, with Mₜₒₜ = Zr + Sn and L = BDC.

After reaction, the samples were isolated via centrifugation or filtration and excess organic ligand washed from the bulk using excess dimethylformamide and the high boiling solvent exchanged with acetone. The samples were then dried at 130° C. to 150° C. under air. X-ray diffraction patterns were taken of the samples. It was found that when the SnCl₂ was combined with high acetic acid ratios (greater than 25 HOAc:BDC), peaks associated with the missing node defects are observable.

FIG. 3 shows the powder X-ray diffraction results of the samples of Table 1 (made in the presence of tin chloride). While the effect of tin is somewhat modest compared to the degree of defects being generated through other methods such as the use of HCl or water as modulators, large pore volumes can be realized from this technique.

FIG. 4 provides the thermogravimetric analysis (“TGA”) of the samples of Table 1 (synthesized in the presence of SnCl₂). The TGA showed that the initial solvent loss from sample 2, 3 and 6, that is the samples showing the greatest missing node defects, was greater than the other samples in this series. As shown in FIG. 4, a temperature between 0° C. and 120° C. represents the occluded solvent in the pore structure and the larger losses correspond to larger pore volumes. A second weight loss between 150° C. to 200° C. is associated with dehydration of the structural nodes.

More particularly, the weight percent of the sample at a temperature ° C. for each of the samples at two different signal values are shown in FIG. 4 and specifically provided below in Table 2. For example, sample 1 has a signal value 1a and a signal value 1b as shown in FIG. 4.

TABLE 2
Weight % and Temperature at Two Signal Values

| | | At signal | | At signal | |
|---|---|---|---|---|---|
| | | value a (FIG. 4) | | value b (FIG. 4) | |
| | | | Temperature | | Temperature |
| Sample | Mg | Weight % | ° C. | Weight % | ° C. |
| 1 | 17.7000 | 72.87 | 349.45 | 35.55 | 810.74 |
| 2 | 28.1300 | 63.44 | 349.10 | 24.84 | 810.27 |
| 3 | 15.1600 | 55.84 | 348.80 | 14.83 | 810.23 |
| 4 | 30.8100 | 70.62 | 348.28 | 35.37 | 809.66 |
| 5 | 33.3500 | 85.37 | 348.02 | 66.63 | 808.26 |
| 6 | 9.1600 | 64.98 | 349.82 | 27.89 | 811.15 |
| 7 | 28.1100 | 72.96 | 347.75 | 43.54 | 809.31 |
| 8 | 22.5800 | 68.26 | 347.38 | 34.77 | 808.89 |

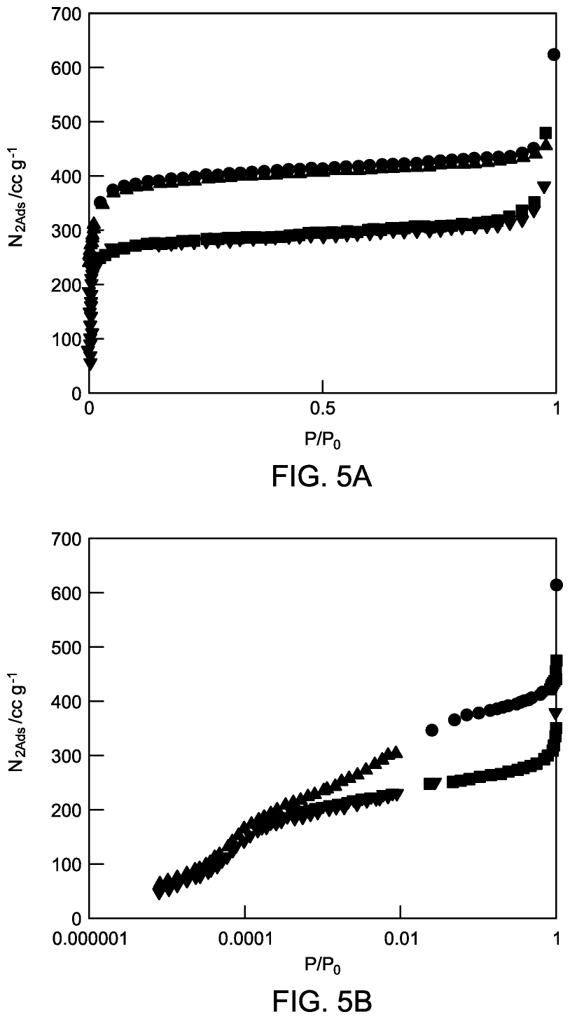

The high pore volumes that resulted in an increase in solvent weight loss were also observed in the nitrogen adsorption isotherms of samples 1 and 2. FIG. 5A and FIG. 5B are the nitrogen adsorption isotherms of sample 1 and 2 described in Table 1, respectively. As shown, both samples had a similar initial uptake of nitrogen (from 10⁻⁵ to 10⁻³ P/P₀). This ostensibly corresponds to the filling of the non-defected regions. However, above these pressures, we observed that sample 2 had a second rising feature associated with the filling of defected regions resulting in a relatively high adsorption capacity of nitrogen of approximately 400 cubic centimeter per gram with only a modest amount of REO defects in the Sn sample. This corresponds to a surface area of 1415 m²/g and a micropore volume of 0.494 cc/g (as measured by t-plot).

### Example 2: Use of Co²⁺ or Zn²⁺ to Induce REO Defects in the Structure of EMM-71

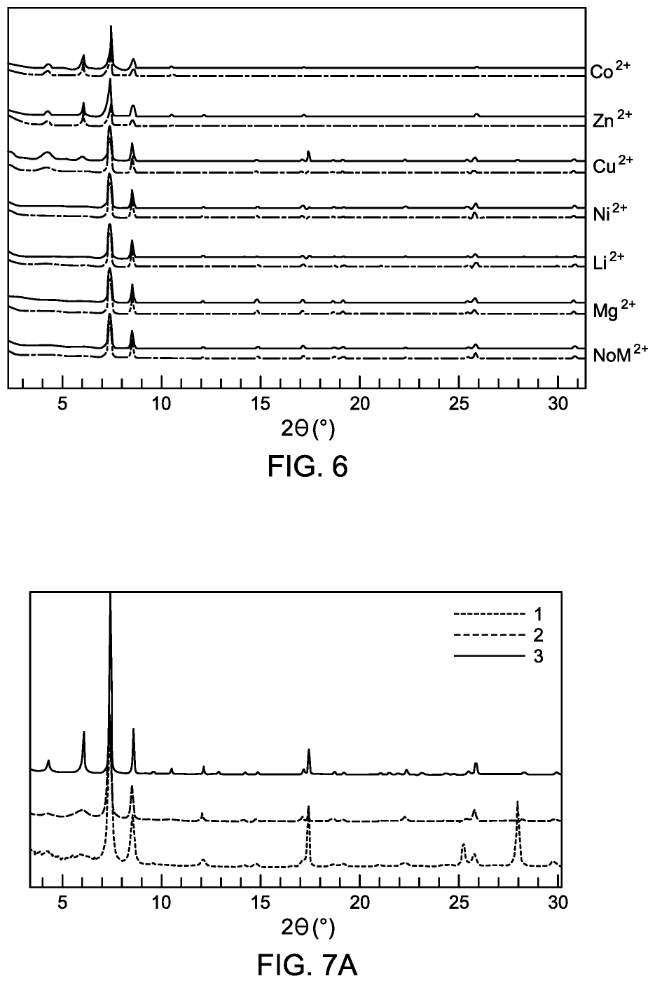

In an effort to evaluate whether this effect translated to other divalent metals, analogous reactions to reactions 2 and 3 were conducted using Mg, Ca, Li, Ni, Cu, Zn, and Co. FIG. 6 show X-ray diffraction patterns of Zr-BDC synthesized in the presence of several metal cations. In the case of each metal, we conducted an equal molar replacement of tin chloride as seen in trial 2 or trial 3. FIG. 6. For magnesium, lithium and nickel, no effect was observed. Copper chloride produced some moderate amounts of node defects under these conditions, but surprisingly, zinc and cobalt were highly effective as producing REO defects at high concentrations and with large domain sizes on par with the size of the primary crystallite size (as determined by shearer broadening).

The formation of defects using this method is somewhat sensitive to the concentration of acetic acid in the solution. Several experiments conducted with cobalt cations demonstrate that when DMF:acetic acid ratios are increased, all else being equal, the defects begin to drop.

TABLE 3
DMF: Acetic Acid Ratio Increasing

| | BDC | ZrOCl₂ | CoCl₂ | DMF | HOAc | Peak | Relative |
|---|---|---|---|---|---|---|---|
| Reaction | (mg) | (mg) | (mg) | (mL) | (mL) | Ratio | Intensity |
| 1 | 441 | 492 | 75 | 5 | 4 | 1.16 | 1.35 |
| 2 | 441 | 492 | 75 | 5 | 3 | 3.6 | 0.44 |
| 3 | 441 | 492 | 75 | 5 | 2 | N/A | N/A |

TABLE 4
DMF: Acetic Acid Ratio Constant

| | BDC | ZrOCl₂ | CoCl₂ | DMF | HOAc | Peak | Relative |
|---|---|---|---|---|---|---|---|
| Reaction | (mg) | (mg) | (mg) | (mL) | (mL) | Ratio | Intensity |
| 1 | 441 | 492 | 75 | 5 | 5 | 1.1 | 2.2 |
| 2 | 441 | 492 | 75 | 4 | 4 | 1.2 | 1.3 |
| 3 | 441 | 492 | 75 | 3 | 3 | 1.2 | 1.8 |

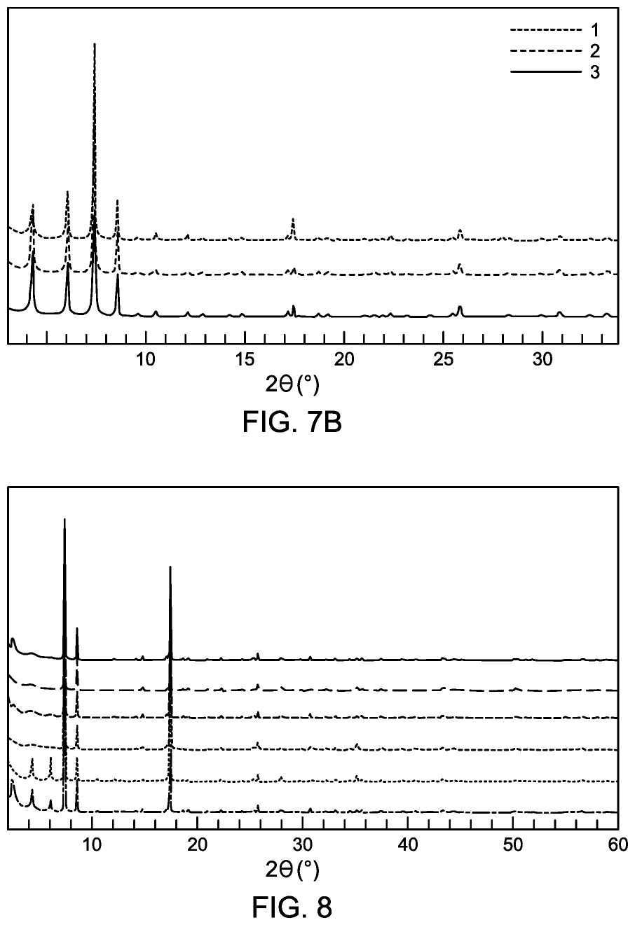

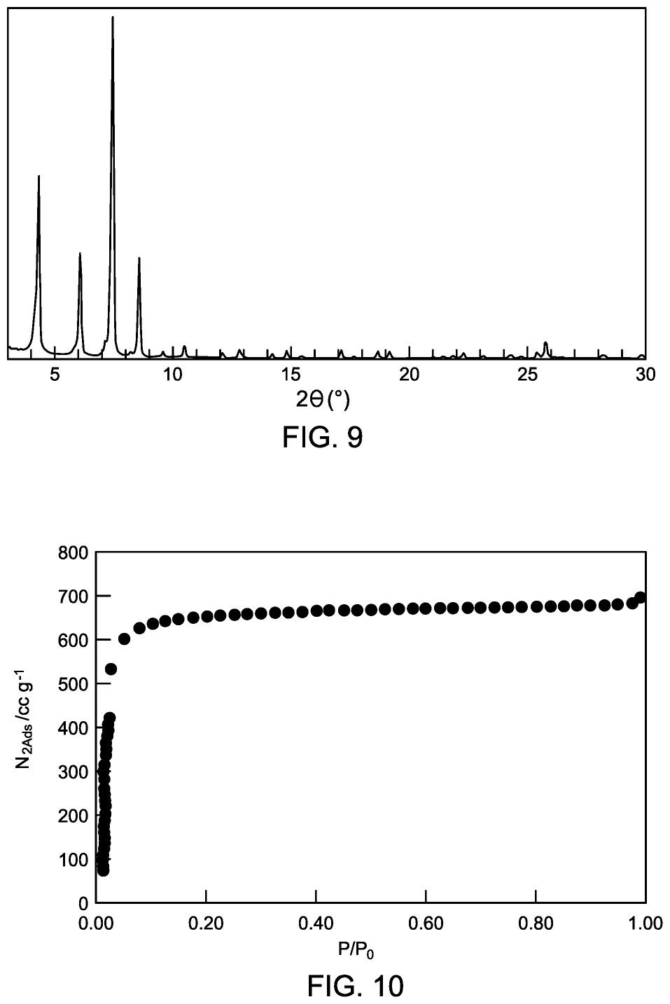

FIG. 7A shows the powder X-ray diffraction patterns of Zr-MOF synthesized in reactions 1, 2 and 3 as set out in Table 3. In addition, FIG. 7B shows the powder X-ray diffraction patterns of Zr-MOF synthesized in reactions 1, 2, 3 as set out in Table 4. As shown, decreasing solution concentrations of acetic acid result in a loss of high ordered defects while this is not related to HOAc:Reagent ratios, as maintaining a constant solvent composition (in terms of HOAc/DMF composition in the present example) will maintain the defects. This highlights the importance of the solvent composition.

In addition to a sensitivity to solvent composition, the effect of the presence of chloride anions was established through trials using nitrate starting materials. Table 5 sets out the reactants as follows.

TABLE 5
Nitrate Starting Materials

| | | ZrO | Co | Zn | HCl | | | | | | | |
|---|---|---|---|---|---|---|---|---|---|---|---|---|
| | BDC | (NO₃)₂ | (NO₃)₂ | (NO₃)₂ | (conc) | H₂O | DMF | HOAc | | | | |
| Rxn | (mg) | (mg) | (mg) | (mg) | (uL) | (uL) | (mL) | (mL) | BDC:Zr * | M²⁺:Zr * | HOAc:L * | Cl:Zr * |
| 1 | 441 | 380 | 0 | 144 | 0 | 185 | 5 | 4 | 1.742 | 0.318 | 26.0 | — |
| 2 | 441 | 380 | 0 | 144 | 0 | 185 | 5 | 5 | 1.742 | 0.318 | 32.4 | — |
| 3 | 441 | 380 | 169 | 0 | 0 | 185 | 5 | 4 | 1.742 | 0.382 | 25.9 | — |
| 4 | 441 | 380 | 169 | 0 | 0 | 185 | 5 | 5 | 1.742 | 0.382 | 32.4 | — |
| 5 | 441 | 380 | 169 | 0 | 120 | 185 | 5 | 4 | 1.742 | 0.382 | 25.9 | 0.95 |
| 6 | 441 | 380 | 169 | 0 | 200 | 185 | 5 | 5 | 1.742 | 0.382 | 32.4 | 1.58 |

* Molar ratios, with M²⁺ = Co and/or Zn and L = BDC.

As shown in FIG. 8, powder X-ray diffraction patterns of the samples of Table 5 synthesized from nitrates salts highlight that large defect domains do not form with either cobalt or zinc cations without the presence of Cl-ions. Reactions 5 and 6 show that the defect structure returns when HCl is introduced as a source of these ions (see two bottom curves of FIG. 8). This corresponds to a relative intensity of 2.3 and 1.7 respectively and a peak ratio of 1.27 and 1.73 respectively.

Large scale preparations of EMM-71 using cobalt chloride were conducted per the methods of Example 2. The conditions as well as the resulting relative intensities and peak ratios are presented in Table 7. The surface area and pore volume were measured after washing the sample with sodium formate. The untreated MOF was suspended in an aqueous 0.25-0.5M sodium formate to create a 10 wt % slurry (10 parts MOF to 90 parts sodium formate solution). The solution was then heated to between 80 and 100° C. for 30-120 minutes. The MOF was then isolated and washed with water or formic acid solution. The samples were exchanged with acetone and then activated under dynamic vacuum at 80-150° C. for 10-12 hours.

TABLE 7

| BDC | ZrOCl₂ | CoCl₂ | DMF | HOAc | | | | |
|---|---|---|---|---|---|---|---|---|
| (g) | (g) | (g) | (mL) | (mL) | L:Zr | HOAc:L | [H₂O] | [L] |
| 22.05 | 24.6 | 3.75 | 250 | 250 | 1.74 | 32.4 | 1.2224 | 0.2657 |
| 15.8 | 24.6 | 3.75 | 220 | 220 | 1.25 | 40 | 1.389 | 0.216 |
| 15.8 | 24.6 | 3.75 | 250 | 250 | 1.25 | 46.3 | 1.2224 | 0.19 |
| 15.8 | 24.6 | 3.75 | 175 | 175 | 1.25 | 32 | 1.7462 | 0.272 |
| 15.8 | 24.6 | 3.75 | 175 | 220 | 1.25 | 40 | 1.5473 | 0.241 |
| 22.05 | 34 | 3.75 | 250 | 250 | 1.25 | 32.3966 | 1.6894 | 0.2657 |
| 15.8 | 24.6 | 3.75 | 220 | 220 | 1.25 | 40 | 1.389 | 0.216 |
| 11.025 | 12.3 | 1.875 | 125 | 125 | 1.7387 | 32.3966 | 1.2224 | 0.2657 |
| 22.05 | 34 | 3.75 | 250 | 250 | 1.258 | 32.3966 | 1.6894 | 0.2657 |
| 22.05 | 34 | 3.75 | 250 | 250 | 1.258 | 32.3966 | 1.6894 | 0.2657 |
| 22.05 | 34 | 3.75 | 250 | 250 | 1.258 | 32.3966 | 1.6894 | 0.2657 |
| 22.05 | 34 | 3.75 | 250 | 250 | 1.258 | 32.3966 | 1.6894 | 0.2657 |
| 17.52 | 34 | 3.75 | 250 | 250 | 0.9995 | 40.7731 | 1.6894 | 0.2111 |
| 22.05 | 43 | 3.75 | 250 | 250 | 0.9947 | 32.3966 | 2.1366 | 0.2657 |
| 11.68 | 34 | 3.75 | 150 | 150 | 0.6664 | 36.6958 | 2.8157 | 0.2345 |
| 15.8 | 24.6 | 2.5 | 220 | 220 | 1.2459 | 39.7863 | 1.389 | 0.2163 |
| 22.05 | 34 | 5 | 250 | 250 | 1.258 | 32.3966 | 1.6894 | 0.2657 |

| | | | | | | Surface | Micropore |
|---|---|---|---|---|---|---|---|
| | | | | Peak | Relative | Area | Volume |
| [M] | CO2:M | Co/Zr | Temp | Ratio | Intensity | (m²/g) | (cc/g) |
| 0.153 | 59.805 | 0.3805 | 130 | 46.2 | 1.52998 | 1996 | 0.784 |
| 0.174 | 52.06 | 0.3805 | 90 | 65.8 | 2.16563 | 1890 | 0.695 |
| 0.153 | 58.819 | 0.3805 | 90 | 74.3 | 1.76397 | 2243 | 0.877 |
| 0.2183 | 41.921 | 0.3805 | 90 | 66.6 | 2.28783 | 1877 | 0.692 |
| 0.193 | 41.921 | 0.3805 | 90 | 32.8 | 1.17669 | 1570 | 0.595 |
| 0.2112 | 43.271 | 0.2753 | 90 | 44.2 | 2.35159 | 1929 | 0.752 |
| 0.174 | 52.06 | 0.3805 | 90 | 68 | 1.98185 | 2637 | 1.025 |
| 0.1528 | 59.805 | 0.3805 | 100 | 76.7 | 1.45347 | 1819 | 0.67 |
| 0.2112 | 43.271 | 0.2753 | 100 | 84.7 | 1.96728 | 2169 | 0.85 |
| 0.2112 | 43.271 | 0.2753 | 110 | 48 | 1.94829 | 1822 | 0.717 |
| 0.2112 | 43.271 | 0.2753 | 90 | 78.2 | 2.31246 | 1685 | 0.652 |
| 0.2112 | 43.271 | 0.2753 | 80 | 73.2 | 2.39609 | 1679 | 0.52 |
| 0.2112 | 42.754 | 0.2753 | 80 | 72.3 | 1.79606 | 1457 | 0.57 |
| 0.2671 | 34.214 | 0.2177 | 80 | 27.1 | 1.50811 | 1309 | 0.514 |
| 0.352 | 25.785 | 0.2753 | 80 | 44.9 | 1.36762 | 1311 | 0.42 |
| 0.1736 | 52.06 | 0.2537 | 90 | 77.2 | 2.09317 | 1631 | 0.59 |
| 0.2112 | 43.271 | 0.3671 | 90 | 64.8 | 1.70087 | 1456 | 0.57 |

### Example 3: Synthesis of EMM-71 Using CuCl₂

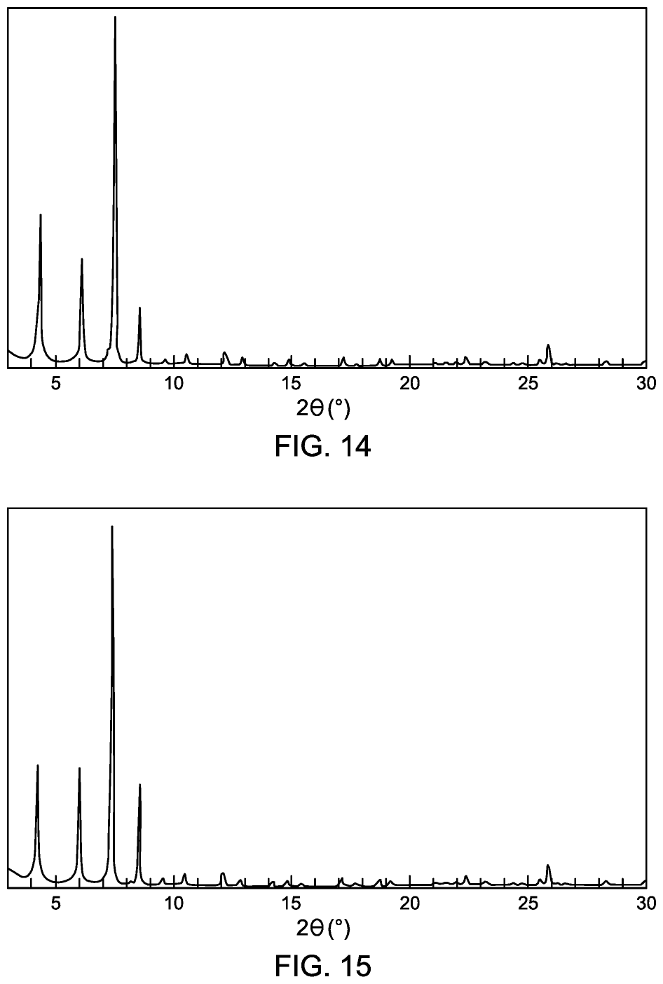

0.449 grams of terephthalic acid, 512 mg of ZrCl₄, and 130 mg of copper chloride dihydrate were added to a 20 mL vial and 5 mL of dimethylformamide and 5 mL of glacial acetic acid were added along with 315 μL of water. The reaction was heated to 90° C. for between 12 and 24 hours and filtered, washed with dimethylformamide and acetone. FIG. 14 is the powder X-ray diffraction pattern of EMM-71 produced in this example. The powder XRD pattern shown in FIG. 14 has a relative intensity of 3.47 and a peak ratio of 1.17.

### Example 4: Synthesis of EMM-71 Using ZnO

78.98 grams of BDC and 90 grams of ZrCl₄ were added to a 1 L round bottom flask. 16 grams of zinc oxide was added. 439 mL of acetic acid was added followed by 439 mL of DMF. Lastly 22.5 mL of water was added. The reaction was then stirred at 80° C. for between 12 and 24 hours. The MOF product was filtered, washed with DMF followed by acetone and dried at 90-130° C. The material was then optionally washed with sodium formate in a similar manner that of materials from Example 2. This sample resulted in a material with a relative intensity of 2.0 and a peak ratio of 1.3. Formate-washed samples exhibited a BET surface area of 2003 m²/g t-plot pore volume of 0.723 cc/g.

### Example 5: Synthesis of Mixed Zr/Hf EMM-71

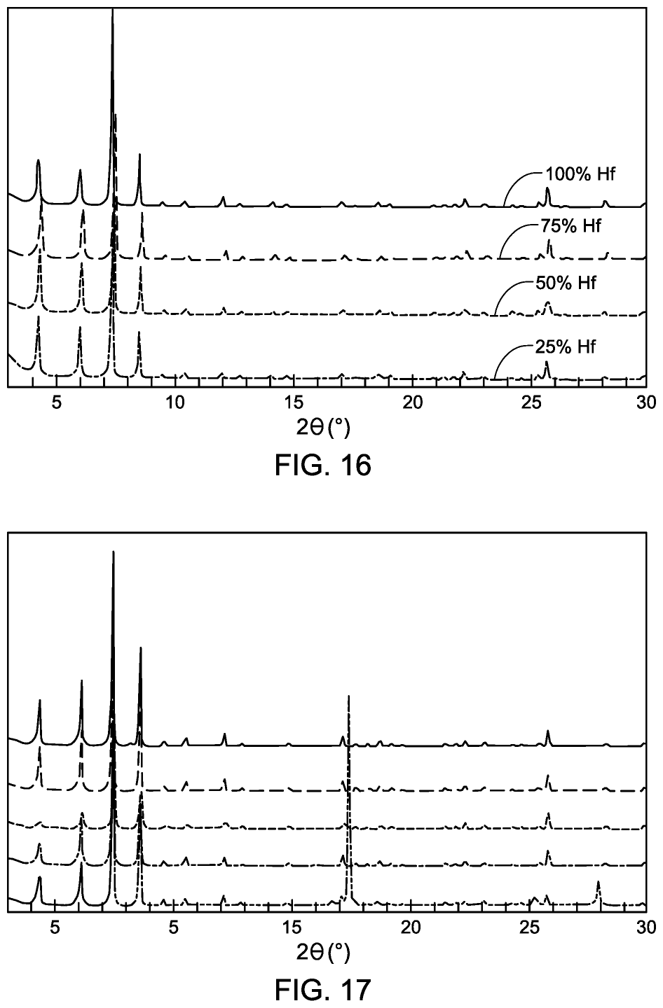

441 mg of terephthalic acid and 393.6 mg of zirconiumoxychloride hydrate was added with 125 mg of hafnium oxychloride hydrate. 5 mL of dimethylformamide and 5 mL of acetic acid were added and the reaction stirred for between 12 and 24 hours at 90° C. The solids were isolated and washed with additional dimethylformamide and then acetone. FIG. 15 is the powder X-ray diffraction pattern of EMM-71 produced in this example. FIG. 16 is the powder X-ray diffraction pattern of Hf—Zr EMM-71 made with different mol % of Hf of total Hf+Zr content. Table 8 shows the conditions used to synthesize the materials in FIG. 16 as well as the calculated relative intensity and peak ratios.

TABLE 8
Mixed Zr/Hf EMM-71

| BDC | ZrOCl₂ | HfOCl₂ | ZnO | DMF | Acetic | Temp | Relative | Peak |
|---|---|---|---|---|---|---|---|---|
| (g) | (g) | (g) | (mg) | (mL) | Acid (mL) | (° C.) | Intensity | Ratio |
| 0.449 | 0.53 | 0.224 | 65 | 5 | 5 | 90 | 2.01 | 1.24 |
| 0.449 | 0.3535 | 0.448 | 65 | 5 | 5 | 90 | 1.76 | 1.33 |
| 0.449 | 0.176 | 0.672 | 65 | 5 | 5 | 90 | 1.57 | 1.34 |
| 0.449 | 0 | 0.896 | 65 | 5 | 5 | 90 | 1.23 | 1.62 |

### Example 6: Time Trials of EMM-71 Formation

3.59 grams of terephthalic acid, 5.59 grams of zirconium oxychloride hydrate and 852 mg of cobalt chloride (anhydrous) were added to 50 mL of dimethylformamide and 50 mL of acetic acid and heated to 90° C. Samples were taken at 45 min, 80 min, 120 min, 195 min, and 255 min. The samples were filtered and washed with acetone. FIG. 17 is the powder X-ray diffraction patterns of EMM-71 aliquots taken at (from bottom to top) 45 min, 80 min, 120 min, 195 min, and 255 min. In these samples, the relative intensity ranges from 1.55 initially and falls to 1.23 at the end of 255 minutes, while the peak ratio varies between 1.08 and 1.26 during the 4 hour run.

### Example 7: Synthesis of EMM-71 Using CoCl₂ and chloro-BDC

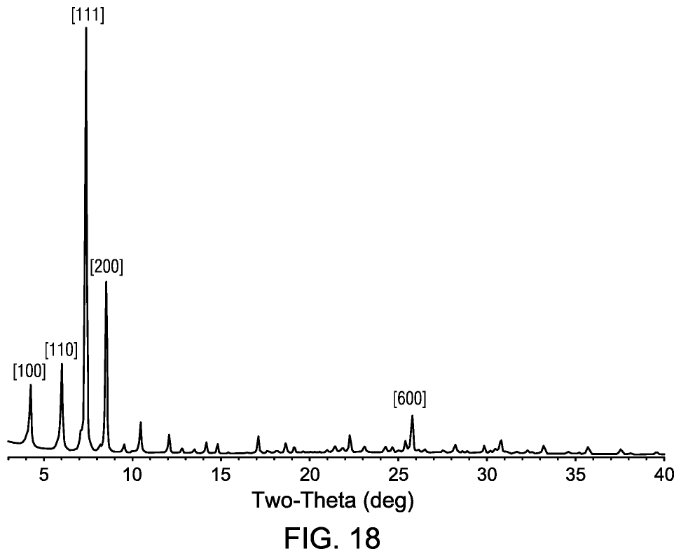

In a 10 mL vial, 0.25 g of 2-chloro-benzenedicarboxylic acid, 0.203 g of ZrCl₄, 0.035 g of CoCl₂, 2 mL of dimethyl formamide (DMF), 3 mL of acetic acid, and 125 μl of deionized (DI) water were mixed together. The obtained mixture was heated at 90° C. for 16 hours with stirring. After cooling down to room temperature, the resulting solid was filtered, washed with DMF and then with acetone. FIG. 18 is the powder X-ray diffraction pattern of EMM-71 produced in this example (relative intensity of 0.81).

### Example 8: Synthesis of EMM-71 Using CoCl₂ and Chloro-BDC

In a 10 mL vial, 0.25 g of 2-chloro-benzenedicarboxylic acid, 0.203 g of ZrCl₄, 0.035 g of CoCl₂, 2 mL of dimethyl formamide (DMF), 3 mL of acetic acid, 20 μl of concentrated HCl, and 63 μl of DI water were mixed together. The obtained mixture was heated at 90° C. for 16 hours with stirring. After cooling down to room temperature, the resulting solid was filtered, washed with DMF and then with acetone. Powder X-ray diffraction pattern was characteristic of EMM-71, with a relative intensity of 0.87.

### Example 9: Synthesis of EMM-71 Using ZnO and Chloro-BDC

In a 20 mL vial, 0.75 g of 2-chloro-benzenedicarboxylic acid, 0.609 g of ZrCl₄, 0.075 g of ZnO, 6 mL of dimethyl formamide (DMF), 9 mL of acetic acid, and 93 μl of DI water were mixed together. The obtained mixture was heated at 90° C. for 16 hours with stirring. After cooling down to room temperature, the resulting solid was filtered, washed with DMF and then with acetone. Powder X-ray diffraction pattern was characteristic of EMM-71, with a relative intensity of 0.95.

### Example 10: Synthesis of EMM-71 Using CoCl₂ and Bromo-BDC

In a 10 mL vial, 0.3 g of 2-bromo-benzenedicarboxylic acid, 0.208 g of ZrOCl₂·H₂O, 0.035 g of CoCl₂, 2 mL of dimethyl formamide (DMF), and 3 mL of acetic acid were mixed together. The obtained mixture was heated at 90° C. for 16 hours with stirring. After cooling down to room temperature, the resulting solid was filtered, washed with DMF and then with acetone. Powder X-ray diffraction pattern was characteristic of EMM-71, with a relative intensity of 1.01.

Additionally or alternately, the invention relates to:

Embodiment 1. A metal-organic framework comprising a plurality of tetravalent cations and terephthalate linkers crystallized in a primitive cubic lattice, wherein the metal-organic framework has a surface area between about 1100 m²/g and 2700 m²/g, a porosity of between about 0.45 cc/g and 1.1 cc/g, and a relative intensity equal to or greater than 0.35.

Embodiment 2. A metal-organic framework material, optionally according to embodiment 1, characterized by the first five diffraction peaks with d spacings at 20.4130, 14.4691, 11.8446, and 10.2594 Å±5% and comprising a primitive cubic cell unit.

Embodiment 3. The metal-organic framework of embodiment 1 or 2, wherein the tetravalent cation is selected from Zr, Ti, Hf, and/or Ce, in particular from Zr and/or Hf.

Embodiment 4. The metal-organic framework of any one of embodiments 1 to 3, wherein the terephthalate linker is selected from 1,4-benzenedicarboxylate (BDC), 2-amino-1,4-benzene dicarboxylate, 1,2,4-benzene tricarboxylate, 1,2,4,5-benzene tetracarboxylate, 2-nitro-1,4,-benzene dicarboxylate, 2-chloro-1,4-benzene dicarboxylate, 2-bromo-1,4-benzene dicarboxylate, and mixtures thereof.

Embodiment 5. The metal-organic framework of any one of the preceding embodiments, further comprising between about 0.0 wt. % and 10.0 wt. % divalent cation.

Embodiment 6. The metal-organic framework of embodiment 4, wherein the divalent cation is selected from Zn, Co, Sn and/or Cu.

Embodiment 7. The metal-organic framework of any one of the preceding embodiments, having at least one of a surface area between about 1400 m²/g and 2400 m²/g, preferably between about 1600 m²/g and 2200 m²/g; a porosity of between about 0.55 cc/g and 0.75 cc/g; and/or a relative intensity of between about 0.45 and 2.9, preferably between about 0.55 or 0.65 to about 2.5 or 2.0.

Embodiment 8. The metal-organic framework of any one of the preceding embodiments, wherein the metal-organic framework has a peak width ratio of less than 3.0, preferably less than 2.5, more preferably less than 2, such as less than 1.50.

Embodiment 9. The metal-organic framework of any one of the preceding embodiments, comprising a plurality of zirconium cations and a plurality of BDC linkers.

Embodiment 10. A metal organic framework comprising a plurality of zirconium cations and BDC linkers in a primitive cubic lattice and less than about 5.0 wt. % of divalent cation, wherein the zirconium-based metal-organic framework has a relative intensity equal to or greater than 0.35 and a peak width ratio of less than 3.0.

Embodiment 11. The metal-organic framework of any one of the preceding embodiments, made by a process comprising the steps of reacting a first metal source that can generate a tetravalent metal cation in solution, a linear dicarboxylic acid, a second metal source that can generate a divalent cation in solution, and one or more monocarboxylic acid modulators in a solvent to provide a reaction solution, and heating the reaction solution to provide a reaction mixture that comprises the metal-organic framework.

Embodiment 12. The metal-organic framework material of any one of the preceding embodiments having a peak width at half maximum ratio of the (110) to (111) reflection is less than 3.

Embodiment 13. A method of making a metal-organic framework, in particular the metal-organic framework of any one of the preceding embodiments, comprising the steps of: (a) reacting a first metal source in the form of a metal precursor, a metal complex or a metal oxide, a polytopic organic carboxylic acid, a second metal source in the form of a metal precursor, a metal complex or a metal oxide, and one or more monocarboxylic acids in a solvent to provide a reaction solution; (b) heating the reaction solution to a reaction temperature of at least 75° C. to provide a reaction mixture wherein the reaction mixture comprises a metal-organic framework material; and (c) separating the metal organic framework material from the reaction mixture.

Embodiment 14. The method of embodiment 13, wherein the first metal source can generate a tetravalent metal cation in solution, in particular wherein the wherein the first metal is selected from zirconium, hafnium, titanium, cerium, or a mixture thereof, such as Zr or a mixture of Zr and Hf.

Embodiment 15. The method of embodiment 13 or 14, wherein the second metal source can generate a divalent metal cation in solution, in particular wherein the second metal is chosen from Zn, Co, Sn, Cu, or a mixture thereof.

Embodiment 16. The method of any one of embodiments 13 to 15, wherein the polytopic organic carboxylic acid can generate terephthalate linkers.

Embodiment 17. The method of any one of embodiments 13 to 16, wherein the polytopic organic carboxylic acid is selected from an aromatic di, tri or tetracarboxylic acid.

Embodiment 18. The method of any one of embodiments 13 to 17, wherein the polytopic organic carboxylic acid is functionalized by an alkyl, halo, nitro, cyano, amino, sulfonyl, thio, isocyano, alcoxy, ether, ester, or carboxylate group.

Embodiment 19. The method of any one of embodiments 13 to 18, wherein the polytopic organic carboxylic acid is selected from the group consisting of 1,4-benzenedicarboxylic acid (terephthalic acid), 2-amino-1,4-benzene dicarboxylic acid, 1,2,4-benzene tricarboxylic acid (trimellitic acid), 1,3,5-benzene tricarboxylic acid (trimesic acid), 1,2,4,5-benzene tetracarboxylic acid, 2-nitro-1,4,-benzene dicarboxylic acid, 2-chloro-1,4-benzene dicarboxylic acid, 2-bromo-1,4-benzene dicarboxylic acid, and mixtures thereof; especially from terephthalic acid and trimesic acid.

Embodiment 20. The method of any one of embodiments 13 to 19, wherein the monocarboxylic acid(s) is selected from formic, acetic, benzoic, difluoroacetic or trifluoroacetic acid.

Embodiment 21. The method of any one of embodiments 13 to 20, wherein the solvent is a polar aprotic solvent, for instance dimethylformamide (DMF).

Embodiment 22. The method of any one of embodiments 13 to 21, wherein the monocarboxylic acid concentration is between about 30 volume % and 70 volume % of the total volume of solvent (calculated as the total volume of monocarboxylic acid(s), solvent(s) and optional water present in the reaction solution).

Embodiment 23. The method of any one of embodiments 13 to 22, wherein tetravalent cation to linker, in particular to terephthalate linker, mol ratio is between about 1.75:1 and about 1:1.75.

Embodiment 24. The method of any one of embodiments 13 to 23, wherein the divalent cation to tetravalent cation mol ratio is from about 0 to about 5, in particular from 0 or from at least 0.1 or from at least 0.15 up to 2 or up to 1 or up to 0.5.

Embodiment 25. The method of any one of embodiments 13 to 24, wherein the reaction solution further comprises water in a concentration between about 0 moles and 5 moles per liter of the total reaction volume.

Embodiment 26. The method of any one of embodiments 13 to 25, wherein the reaction solution further comprises one or more of F, Cl, Br or I ions, in particular Cl.

Embodiment 27. The method of any one of embodiments 13 to 26, wherein the metal-organic framework material comprises a plurality of metal-organic frameworks, each of the plurality of metal-organic frameworks having a plurality of tetravalent cations and terephthalate linkers crystallized in a primitive cubic lattice, with less than about 5.0 wt. % of divalent cation and a relative intensity equal to or greater than 0.35.

Embodiment 28. A method of modulating a defect structure or a morphology of a metal organic framework comprising the step of synthesizing the metal organic framework in the presence of a secondary metal or secondary metal cations.

Embodiment 29. The method of embodiment 28, wherein the metal organic framework comprises a first metal that has a different valence than the secondary metal or secondary metal cations.

Embodiment 30. The method of embodiment 28 or 29, wherein the metal or first metal is a tetravalent metal or tetravalent metal cations, in particular selected from Zr, Ti, Hf, Ce, or a mixture thereof, more particularly Zr or a mixture of Zr and Hf.

Embodiment 31. The method of any one of embodiments 28 to 30, wherein the secondary metal or secondary metal cations is a divalent metal or divalent metal cations, in particular selected from Zn, Co, Sn, Cu, or a mixture thereof.

Embodiment 32. The metal-organic framework or method of any one of the preceding embodiments, wherein the metal-organic framework comprises a plurality of tetravalent cations, in particular a plurality of zirconium cations, and terephthalate linkers crystallized in a primitive cubic lattice.

Embodiment 33 The metal-organic framework or method of any one of the preceding embodiments, wherein the metal-organic framework primarily has a REO topology, in particular a REO topology with FCU defects.

Embodiment 34 The metal-organic framework or method of any one of the preceding embodiments, wherein the metal-organic framework is REO-UiO-66 or EMM-71.

All numerical values within the detailed description and the claims can modified by “about” or “approximately” the indicated value, taking into account experimental error and variations.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

When numerical lower limits and numerical upper limits are listed herein, ranges from any lower limit to any upper limit are contemplated. Although the present disclosure has been described in terms of specific aspects, it is not so limited. Suitable alterations/modifications for operation under specific conditions should be apparent to those skilled in the art. It is therefore intended that the following claims be interpreted as covering all such alterations/modifications as fall within the true spirit/scope of the disclosure.

1-27. (canceled)

28. A metal-organic framework comprising a plurality of tetravalent cations and terephthalate linkers crystallized in a primitive cubic lattice, wherein the metal-organic framework has a surface area between about 1100 m²/g and 2700 m²/g, a porosity of between about 0.45 cc/g and 1.1 cc/g, and a relative intensity equal to or greater than 0.35.

29. The metal-organic framework of claim 28, wherein the tetravalent cation is selected from Zr, Ti, Hf, and/or Ce.

30. The metal-organic framework of claim 28, wherein the terephthalate linker is selected from 1,4-benzenedicarboxylate (BDC) or derivative thereof, 2-amino-1,4-benzene dicarboxylate, 1,2,4-benzene tricarboxylate, 1,2,4,5-benzene tetracarboxylate, 2-nitro-1,4,-benzene dicarboxylate, 2-chloro-1,4-benzene dicarboxylate, 2-bromo-1,4-benzene dicarboxylate, and mixtures thereof.

31. The metal-organic framework of claim 28, further comprising between about 3.0 wt. % and 10.0 wt. % divalent cation selected from Zn, Co, Sn and/or Cu. [par. 45 for minimal amount of divalent cation]

32. The metal-organic framework of claim 28, comprising a plurality of zirconium cations and a plurality of BDC linkers.

33. A metal organic framework comprising a plurality of zirconium cations and BDC linkers in a primitive cubic lattice and less than about 5.0 wt. % of divalent cation, wherein the zirconium-based metal-organic framework has a relative intensity equal to or greater than 0.35 and a peak width ratio of less than 3.0.

34. A metal-organic framework material characterized by the first five diffraction peaks with d spacings at 20.4130, 14.4691, 11.8446, and 10.2594 Å±5% and comprising a primitive cubic cell unit.

35. The metal-organic framework material of claim 28 having a peak width at half maximum ratio of the (110) to (111) reflection of less than 3.

36. A method of making a metal-organic framework comprising the steps of:
reacting a first metal source in the form of a metal precursor, a metal complex or a metal oxide, a polytopic organic carboxylic acid, a second metal source in the form of a metal precursor, a metal complex or a metal oxide, and one or more monocarboxylic acids in a solvent to provide a reaction solution, wherein the first metal source can generate a tetravalent metal cation in solution, the second metal source can generate a divalent metal cation in solution, and the polytopic organic carboxylic acid can generate terephthalate linkers;
heating the reaction solution to a reaction temperature of at least 75° C. to provide a reaction mixture wherein the reaction mixture comprises a metal-organic framework material; and
separating the metal organic framework material from the reaction mixture.

37. The method of claim 36, wherein the monocarboxylic acid concentration is between about 30 volume % and 70 volume % of the total volume of solvent.

38. The method of claim 36, wherein tetravalent cation to linker mol ratio is between about 1.75:1 and about 1:1.75.

39. The method of claim 36, wherein the divalent cation to tetravalent cation mol ratio is from about 0.05 to about 5:1.

40. The method of claim 36, wherein the reaction solution further comprises water in a concentration between about 0 moles and 5 moles per liter.

41. The method of claim 36, wherein the first metal is selected from zirconium, hafnium, titanium, cerium, or a mixture thereof, and the second metal is chosen from Zn, Co, Sn, Cu, or a mixture thereof.

42. The method of claim 36, wherein the polytopic organic carboxylic acid is selected from an aromatic di, tri or tetracarboxylic acid.

43. The method of claim 36, wherein the polytopic organic carboxylic acid is selected from terephthalic acid or trimesic acid.

44. The method of claim 36, wherein the reaction solution further comprises one or more of F, Cl, Br or I ions.

45. A method of modulating a defect structure or a morphology of a metal organic framework comprising the step of synthesizing the metal organic framework in the presence of a secondary metal or secondary metal cations, wherein the metal organic framework comprises a first metal that has a different valence than the secondary metal or secondary metal cations, and wherein the metal or first metal is a tetravalent metal or tetravalent metal cations and the secondary metal or secondary metal cations are a divalent metal or divalent metal cations.

46. The method of claim 45, wherein the metal or first metal is selected from Zr, Ti, Hf, Ce, or a mixture thereof, and the secondary metal or secondary metal cations is selected from Zn, Co, Sn, Cu, or a mixture thereof.

47. The method of claim 45, wherein the metal organic framework comprises a plurality of zirconium cations, and terephthalate linkers crystallized in a primitive cubic lattice.
